(19) United States
(12) Patent Application Publication
(10) Pub. No.: US 2018/0032674 A1
(43) Pub. Date: Feb. 1, 2018

(54) DIAGNOSTIC SYSTEM, DIAGNOSTIC METHOD, AND STORAGE MEDIUM

(71) Applicant: Kazushige ASADA, Kanagawa (JP)

(72) Inventor: Kazushige ASADA, Kanagawa (JP)

(21) Appl. No.: 15/650,426

(22) Filed: Jul. 14, 2017

(30) Foreign Application Priority Data
Jul. 28, 2016 (JP) 2016-148873

(51) Int. Cl. G06F 19/00; G02B 13/08; G02B 17/06; G06F 11/22

(52) U.S. Cl. CPC G06F 19/32; G06F 11/2289; G02B 13/08; G02B 17/0663; G02B 26/0833

(57) ABSTRACT

A diagnostic system includes circuitry configured to receive an input of life pattern data of a diagnosis-target person, estimate diagnosis data of the diagnosis-target person by applying correlation data, generated by correlating life pattern data and diagnosis data of persons already diagnosed of mental disorder, to the life pattern data of the diagnosis-target person, and control output of the estimated diagnosis data of the diagnosis-target person.

This application claims priority pursuant to 35 U.S.C. §119(a) to Japanese Patent Application No. 2016-148873 filed on Jul. 28, 2016 in the Japan Patent Office, the disclosure of which is incorporated by reference herein in its entirety.

### BACKGROUND

### Technical Field

This disclosure relates to a diagnostic system, a diagnostic method, and a storage medium.

### Background Art

The diagnostic criteria for depression is defined by standards issued by several organizations. For example, “ICD-10” that is the International Classification of Diseases of World Health Organization (WHO) or Diagnostic and Statistical Manual of Mental Disorders, fifth edition “DSM-5” of American Psychiatric Association are typically used as the standards of the diagnostic criteria. Although these diagnostic criteria are qualitative, physicians specializing in mental disorders can make reliable diagnosis from experiences with many patients.

However, when a person is to be diagnosed by a doctor, the person needs to go to a medical institution. Therefore, it is necessary that the person is aware that he or she is depressed or has a mental state close to the depression, and then it is assumed that he or she will go to the medical institution himself/herself depending on the intention of the person or the recommendation of other person. However, in order to avoid prejudice and inconvenience caused by being depressed, persons tend to not to admit the depression, and tend to conceal symptoms of the depression. Further, other persons often do not notice that he or she is depressed. For this reason, there are cases where persons become severe without being diagnosed or examined at medical institutions.

In view of these issues, there is an attempt to estimate the risk of depression from daily behavior of person, and to discover depressed persons at an early stage. For example, a mental health management support method is disclosed, in which in-house life logs that are information related to working situation of employees in the workplaces, environmental life logs that are information related to work environment in the workplaces, and general life logs that are information related to daily activities of employees are collected, and then a risk value relating to mental health is calculated based on the life log of a specific day and the life log of a disorder person.

However, this technique may have a problem that reliability of the calculated risk value is not so high. For example, in this technique or in any diagnostic tool which employs this technique, a medical criteria is not used to determine whether a person has a disorder, the life log of the person with a disorder may not be the life log of the person with depression actually, and the life log determined as the healthy person is actually the life log of the person with depression. Therefore, depressed persons may not be detected at an early stage from the risk value calculated based on the life log of the specific day and the life log of the disorder persons

### SUMMARY

As one aspect of the present invention, a diagnostic system is devised. The diagnostic system includes circuitry configured to receive an input of life pattern data of a diagnosis-target person, estimate diagnosis data of the diagnosis-target person by applying correlation data, generated by correlating life pattern data and diagnosis data of persons already diagnosed of mental disorder, to the life pattern data of the diagnosis-target person, and control output of the estimated diagnosis data of the diagnosis-target person.

As another aspect of the present invention, a method of performing a diagnosis is devised. The method includes receiving an input of life pattern data of a diagnosis-target person, estimating diagnosis data of the diagnosis-target person by applying correlation data, generated by correlating life pattern data and diagnosis data of persons already diagnosed of mental disorder, to the life pattern data of the diagnosis-target person, and outputting the estimated diagnosis data of the diagnosis-target person.

As another aspect of the present invention, a non-transitory storage medium storing a program that, when executed by a computer, causes the computer to execute a method of performing a diagnosis is devised. The method includes receiving an input of life pattern data of a diagnosis-target person, estimating diagnosis data of the diagnosis-target person by applying correlation data, generated by correlating life pattern data and diagnosis data of persons already diagnosed of mental disorder, to the life pattern data of the diagnosis-target person, and controlling output of the estimated diagnosis data of the diagnosis-target person.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIGS. 1A and 1B illustrate an outline of calculation methods of a risk value;

FIG. 2 illustrates an example of a schematic configuration of a diagnostic system;

FIG. 3 illustrates an example of a hardware block diagram of terminals and apparatuses employed in the diagnostic system;

FIG. 4 illustrates an example of a functional block diagram of the terminals and the apparatuses employed in the diagnostic system;

FIGS. 5A and 5B illustrate an example of neural networks used as one example model of a machine learning;

FIG. 6 is a flow chart illustrating the steps of a process of registering diagnosis data by a diagnostic service provider;

FIG. 7 is a flow chart illustrating the steps of a process of reporting an update of diagnosis data to a database management apparatus by a diagnostic service provider;

FIG. 8 is a flow chart illustrating the steps of a process of registering biomarker data by a diagnostic service provider;

FIG. 9 is a flow chart illustrating the steps of a process of registering life log data by a diagnostic service provider;

FIG. 10 is a flow chart illustrating the steps of a process of registering diagnosis-target person by a diagnostic service provider;

FIG. 11 is a flow chart illustrating the steps of a process of registering recommended information by a diagnostic service provider;

FIG. 12 is a flow chart illustrating the steps of a process of data operation performable by a database management apparatus;

FIG. 13A is a flow chart illustrating the steps of a process of calculating a risk value by a risk value calculation apparatus, and FIG. 13B is a sequential diagram of processing performable by the diagnostic system substantially corresponding to the steps of the calculating the risk value of FIG. 13A;

FIG. 14 is a flow chart illustrating the steps of a process of registering history by a history management apparatus;

FIG. 15A is a flow chart illustrating the steps of a process of calculating a risk value with a chronological order by the risk value calculation terminal, and FIG. 15B is a sequential diagram of processing performable by the diagnostic system substantially corresponding to the steps of the process of calculating the risk value of FIG. 15A;

FIG. 16 illustrates an example of a risk value screen displayable on a display of a risk value calculation terminal;

FIG. 17 is a flow chart illustrating the steps of a process of calculating correlation data based on two estimated diagnosis data;

FIG. 18 is Table 1 indicating an example of data registered in a diagnosis database;

FIG. 19 is Table 2 indicating diagnosis types of DSM-5;

FIG. 20 is Table 3 indicating an example of data registered in a biomarker database;

FIG. 21 is Table 4 indicating an example of biomarkers;

FIG. 22 is Table 5 indicating an example of data registered in a life log database;

FIG. 23 is Table 6 indicating an example of life log types registered in a life log database;

FIG. 24 is Table 7 indicating an example of data registered in a diagnosis-target database;

FIG. 25 is Table 8 indicating an example of data registered in a recommended information database; and

FIG. 26 is Table 9 indicating an example of data registered in a history database.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of present disclosure. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of present disclosure.

In addition, it should be noted that the terminology used herein is for the purpose of describing particular embodiments only and is not intended to be limiting of present disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. Furthermore, although in describing views illustrated in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more embodiments are described hereinafter.

Hereinafter, a description is given of one or more embodiments of the present disclosure with reference to drawings.

### (Outline of Calculation of Risk Value)

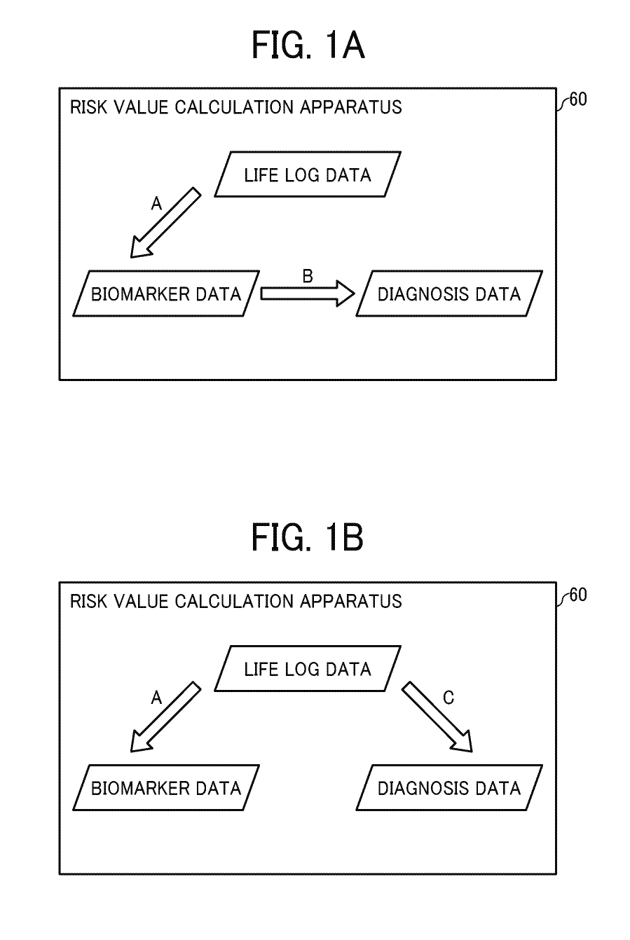

FIG. 1A illustrates an outline of one calculation method of a risk value. A risk value calculation apparatus 60, used as a diagnostic apparatus, acquires life log data of persons such as depression patients and healthy persons, biomarker data of persons such as depression patients and healthy persons, and diagnosis data of persons such as depression patients and healthy persons. The depression patients are persons diagnosed and determined by doctors having depression, and healthy persons are persons diagnosed by doctors not having depression or not having any risk of depression. The diagnosis data is acquired as diagnosis result of a doctor based on “ICD-10” that is the International Classification of Diseases of World Health Organization (WHO) or Diagnostic and Statistical Manual of Mental Disorders, fifth edition “DSM-5” of American Psychiatric Association.

A biomarker is a substance such as protein, which is measured in body fluid, and the concentration of biomarker may reflect the presence and degree of progression of a certain disease. In general, a biomarker is an indicator of a specific disease state and life state. Typically, a doctor asks a patient to obtain information on symptoms of the patient, and judges whether the patient has depression or not, but the declaration of the symptoms based on the interview may be based on the subjectivity of the patient. When the patient subjectivity reports his/her symptom too much or too little, a diagnosis by the doctor may not become an appropriate diagnosis result. Therefore, an accurate diagnosis of depression is difficult for the doctor. When the diagnosis performed accurately, a patient who is not depressed is diagnosed as not depressed, and a patient who is depressed is diagnosed as depressed.

Therefore, a method of using a biomarker as a diagnostic method of depression is known, in which subjective judgment of a doctor or a patient is not used, and the biomarker can be become an objective and quantitative indicator of depression. However, the diagnosis based on the biomarkers alone is not fully researched and developed, and the reliability of diagnosis based on the biomarkers alone is not yet sufficient.

Based on such assumption, the risk value calculation apparatus 60 of an embodiment estimates biomarker data and diagnosis data or diagnostic data of a diagnosis-target person by applying the following methods in this disclosure.

A description is given of one method of calculating the risk value with reference to FIG. 1A.

A) The risk value calculation apparatus 60 calculates a correlation between life log data of persons (i.e., depression patients and healthy persons), and biomarker data of the persons (i.e., depression patients and healthy persons).

B) Then, the risk value calculation apparatus 60 calculates a correlation between the biomarker data of the persons (i.e., depression patients and healthy persons), and the diagnosis data of the persons (i.e., depression patients and healthy persons).

When these correlations are calculated, the biomarker data of the diagnosis-target person can be estimated from an input of the life log data of the diagnosis-target person, and then the diagnosis data of the diagnosis-target person can be estimated from the estimated biomarker data of the diagnosis-target person. Although the doctor's diagnosis may be subjective, if diagnosis data of the persons (i.e., depression patients and healthy persons) exists with a statistically enough level, reliability of diagnosis data becomes higher. Therefore, if the life logs of the diagnosis-target person are collected, a diagnosis result equivalent to the doctor's diagnosis can be estimated without going to a medical institution, with which early diagnosis becomes possible.

In the embodiment, the objective and quantitative indicator of biomarker data is used, but it is difficult to identify whether the diagnosis-target person is depressed or not using only the biomarker data. However, when the diagnosis data is estimated with the biomarker data, which is an objective and quantitative index of data, an adverse effects of subjective diagnosis can be reduced, and the meaning of the biomarker data can be defined by the diagnosis data (e.g., when diagnosis is depressed, an estimation value of a specific biomarker data is increased). Therefore, the diagnosis-target person or the concerned party/person can check the biomarker data, and change the life-related activity of the diagnosis-target person to improve the biomarker data. Therefore, the diagnostic system 100 can provide an indicator (or motivation) to improve life-related activity of the diagnosis-target person.

A description is given of another method of calculating the risk value with reference to FIG. 1B. FIG. 1B illustrates an example of another method of estimating a correlation between life log data and biomarker data, and a correlation between life log data and diagnosis data. As illustrated in FIG. 1B, the risk value calculation apparatus 60 can estimate the biomarker data from the life log data, and the diagnosis data from the life log data.

A) The risk value calculation apparatus 60 calculates a correlation between the life log data of persons (e.g., depression patients and healthy persons), and biomarker data of persons (e.g., depression patients and healthy persons).

C) Then, the risk value calculation apparatus 60 calculates a correlation between the life log data of persons (e.g., depression patients and healthy persons), and the diagnosis data of persons (e.g., depression patients and healthy persons).

When these correlations are calculated, the biomarker data of the diagnosis-target person can be estimated from the life log data of the diagnosis-target person, and the diagnosis data of the diagnosis-target person can be estimated from the life log data of the diagnosis-target person. Therefore, as similar to the case of FIG. 1A, the early diagnosis becomes possible. Further, since the diagnosis data is estimated directly from the life log data, it can be expected that reliability of the estimated value of the diagnosis data is improved.

The above two examples represent a significant improvement to the underlying technological field of medical diagnostic tools. As mentioned above, in conventional diagnostic tools, medical criteria is not used to determine whether a person has a disorder. Moreover, such tools do not correlate received life log data with one or both of stored biomarker data and diagnostic data in order to output an estimated biomarker data and diagnostic data. Therefore, the present embodiments provide a clear and objective output as an early diagnosis of depression based only on an input of life log data of a diagnosis-target person.

Additionally, the present embodiments are more than a data gathering, data storing, or data outputting process, and they are more than an execution of mathematical operations on a machine. The present embodiments achieve a tangible result based on taking inputted data unique to a particular person and transforming this data into a meaningful output that can provide an early diagnosis of depression.

In the following description, the description will be made assuming that diagnosis data is estimated by applying the estimation method of FIG. 1A unless otherwise specified.

### (Terms)

In this description, the life-related activity means activities on daily life, and human activities that may be related with mental disorder. The life-related activity data is numerical data of the life-related activity. Hereinafter, the life-related activity is referred to as a life log, and data of the life-related activity is referred to as life log data or life pattern data.

In this description, an already diagnosed person is a person who has received a diagnosis related to a mental disorder from a doctor or a medial person having a capability compatible to the doctor. The diagnosis means that the risk of a mental disorder is judged to be high or low according to given diagnostic criteria. Alternatively, the degree of mental disorder may be judged in multiple stages. The diagnosis data is numerical data corresponding to contents of the diagnosis.

In this description, biomedical information is information of substance detected from blood, saliva, exhalation, tears, and perspiration of a diagnosis-target person. Alternatively, the biomedical information can be information of substance in the body that may be related with mental disorder. Further, the biomedical information includes blood pressure, brain wave, and heart beat that can be measured and digitized. The measurement value of the biomedical information is obtained by converting the measured value of the biomedical information into data. Hereinafter, the term of biomarker is used as an example of the biomedical information, and the term of biomarker data is used as an example of measured values of the biomedical information.

In this description, the mental disorder means that a mental condition of a person is bad or mental health of a person is impaired. In this disclosure, an early diagnostic method of depression is described, in which the depression is as an example of a mental disorder. However, the mental disorder includes others such as schizophrenia, mania, neurosis, personality disorder, eating disorder, psychosomatic disorder, and so on, and the diagnostic method of the embodiment can be also applied to these disorders. Since mental disorder is not fully researched, and the mental disorder definition and diagnostic criteria are not unified, the illness name may change depending on the classification method of mental disorder even if the same symptom is diagnosed.

### (System Configuration)

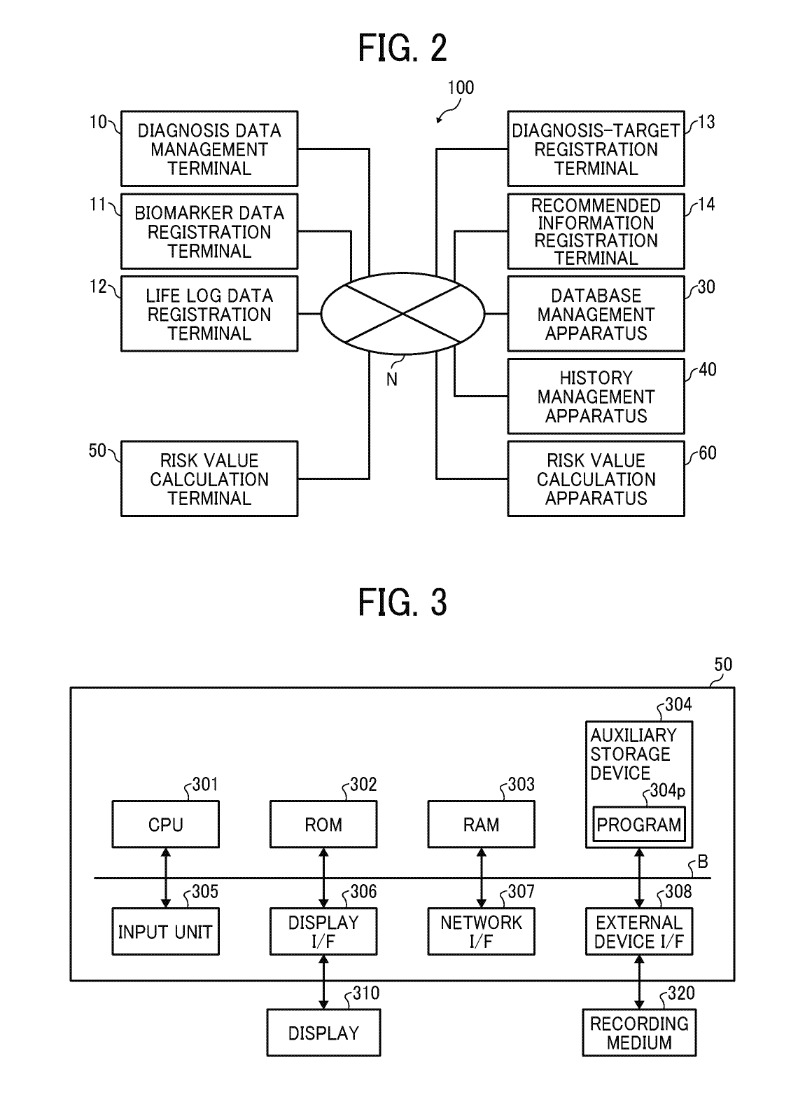

FIG. 2 illustrates an example of a schematic configuration of a diagnostic system 100 of the embodiment. As illustrated in FIG. 2, the diagnostic system 100 includes, for example, a diagnosis data management terminal 10, a biomarker data registration terminal 11, a life log data registration terminal 12, a risk value calculation terminal 50, a diagnosis-target registration terminal 13, a recommended information registration terminal 14, a database management apparatus 30, a history management apparatus 40, and a risk value calculation apparatus 60. If these terminals and apparatuses are not distinguished, they are referred to as “terminals or apparatuses.” These terminals or apparatuses are communicatively connected with each other via a network N. There is no meaning that these terminals and apparatuses are disposed at the right side and the left side of the network N in FIG. 2. Although the difference between the nomenclature of the terminal and the apparatus does not mean the difference in the hardware configuration, the terminal may provide a function of a user interface for inputting and outputting information, and the apparatus may processes information input to the apparatus. However, the terminal can be referred to as an apparatus, or the apparatus can be referred to as a terminal.

The network N includes, for example, a local area network (LAN) built in a facility where each terminal or apparatus is installed, a provider network of a provider that connects the LAN to the Internet, and a line provided by a line operator. In a case that the network has multiple LANs, the network N is called as wide area network (WAN) and the Internet. The network N can be configured either wired or wirelessly, or the network N can be configured by both of wired and wirelessly. Further, when the terminal and the apparatus are directly connected to the public network, the terminal and the apparatus can be connected to the provider network without using the LAN.

Further, each of the terminals and the apparatuses has a function of an information processing apparatus, which is known, for example, as a server and a personal computer (PC). Further, each of the terminals and the apparatuses can be a portable mobile terminal. The mobile terminal includes, for example, a smart phone, a mobile phone, a tablet terminal, a personal digital assistant (PDA), a digital camera, a wearable PC, a notebook PC, and a game machine, but not limited to these. Further, each of the terminals and the apparatuses can be office equipment. The office equipment includes apparatuses mainly used in offices, but not limited to the office uses. The office equipment includes, for example, an image forming apparatus (e.g., printer, multi-functional peripheral (MFP), copier), a facsimile machine, a scanner, a copy machine or the like. Further, each of the terminals and the apparatuses can be a projector, a head up display (HUD) apparatus, an electronic information board, and a digital signage.

Further, cloud computing can be applied to one or more terminals and apparatuses. The cloud means that a specific hardware resource is not used. In the cloud computing, the hardware is not housed in one casing or the hardware is not provided as a unitary apparatus, but the hardware resources are dynamically connected and disconnected according to the processing load level. Further, a plurality of server functions can be built in a virtual environment in one information processing apparatus, or one server function can be established by using a plurality of information processing apparatuses.

A description is given of each of the terminals and the apparatuses. The diagnosis data management terminal 10 is a terminal used by a diagnostic service provider to register diagnosis data of persons such as depression patients and healthy persons. The diagnostic service provider is an operator involved in the diagnostic system 100 such as an operation person, an administrator, a provider, or a person in charge of the diagnostic system 100. Further, the diagnostic service provider can be medical personnel. In this description, the term diagnostic service provider may refer to the same person or other person.

The biomarker data registration terminal 11 is a terminal used by the diagnostic service provider to register biomarker data of persons such as depression patients and healthy persons to the database management apparatus 30.

The life log data registration terminal 12 is a terminal used by the diagnostic service provider to register life log data of persons such as depression patients and healthy persons to the database management apparatus 30. The life log data is to be described later in this description. For example, the life log data of persons such as depression patients and healthy persons can be collected by wearable terminals put on persons such as depression patients and healthy persons, and then transmitted to the life log data registration terminal 12 or the database management apparatus 30 by wire or wirelessly. The wearable terminal may include one or more sensors configured to capture certain data related to the patient. Such sensed data may include certain biomarker data described above, such as perspiration, blood pressure, brain wave, and heartbeat. The sensed data may also include movement and activity data. The data collected by the wearable terminal may be transmitted to the life log data registration terminal or directly to another device in the system either based on a user input or automatically according to a predetermined timing. Further, the life log data can be input based on answers of persons such as depression patients and the healthy persons to questionnaire.

The diagnosis-target registration terminal 13 is a terminal used by the diagnostic service provider to register information on a diagnosis-target person. The diagnosis-target person is a person to be diagnosed by the diagnostic system 100. For example, the diagnosis-target person is a person to be judged having the depression symptom and/or tendency of the depression symptom based on the life log data. The diagnosis-target person is, for example, an employee of a company that have introduced the diagnostic system 100, a customer visiting a shopping mall, residents belonging to public organizations. The information on the diagnosis-target person is referred to as “diagnosis-target data.” An example of the diagnosis-target data is to be described later in this description. For example, the diagnosis-target data includes information for identifying the diagnosis-target person and contact information of the diagnosis-target person.

The recommended information registration terminal 14 is a terminal used by the diagnostic service provider to register recommended information for the diagnosis-target person such as recommended activity for the diagnosis-target person. The recommended information includes information of life-related activity and various information recommended for the diagnosis-target person to reduce the risk level of the depression symptom of the diagnosis-target person. For example, the recommended information includes advices to be taken into consideration by the diagnosis-target person in daily life, information of food to be ingested by the diagnosis-target person in daily life, and effective exercise for the diagnosis-target person. Further, in this configuration, the diagnostic service provider is preferably a medical person.

The database management apparatus 30 stores the diagnosis data registered by using the diagnosis data management terminal 10, the biomarker data registered by using the biomarker data registration terminal 11, the life log data registered by using the life log data registration terminal 12, the diagnosis-target data registered by using the diagnosis-target registration terminal 13, and the recommended information registered by using the recommended information registration terminal 14 in databases, and manages theses databases. Further, in response to a request from the risk value calculation terminal 50 and/or the risk value calculation apparatus 60, the database management apparatus 30 searches and reads out the diagnosis data, the biomarker data, the life log data, the diagnosis-target data, and the recommended information from these databases, and provides the data to a data requester.

The risk value calculation terminal 50 is a terminal used by the diagnosis-target person or the concerned party/person to input life log data of the diagnosis-target person, and to display a risk value of depression symptom of the diagnosis-target person. The estimated diagnosis data is provided to the diagnosis-target person or the concerned party/person with the risk value indicating whether the diagnosis-target person is likely to become depression as an easily understandable data style. For example, the risk value includes, “depression symptom,” “not depression symptom,” “to become depression symptom easily,” “not to become depression symptom easily,” multiple-staged risk levels such as A to E or 1 to 10, and risk levels indicated by numerical values from 0 to 100. The risk value is calculated from the diagnosis data by using a calculation method, which can be determined depending on the diagnosis-target person or the concerned party/person. Further, the life log data of the diagnosis-target person can be input from the risk value calculation terminal 50.

In response to a request from the risk value calculation terminal 50, the risk value calculation apparatus 60 calculates an estimation value of the biomarker data, an estimation value of the diagnosis data, and the risk value, and provides the calculated estimation value biomarker data, the calculated estimation value of the diagnosis data, and the calculated risk value to the risk value calculation terminal 50.

In response to a request from the risk value calculation terminal 50, the history management apparatus 40 registers the life log data of the diagnosis-target person to the database management apparatus 30. The history management apparatus 40 registers the life log data of the diagnosis-target person to be used for a calculation operation by the risk value calculation apparatus 60.

Among the components for configuring the diagnostic system 100, the diagnosis data management terminal 10, the biomarker data registration terminal 11, the life log data registration terminal 12, the diagnosis-target registration terminal 13, the recommended information registration terminal 14, the database management apparatus 30, and, the risk value calculation apparatus 60 may be managed by the diagnostic service provider. Therefore, these terminals and the apparatuses are mainly used by the diagnostic service provider. For example, the diagnostic service provider may set a Web server, and the diagnosis data management terminal 10, the biomarker data registration terminal 11, the life log data registration terminal 12, the diagnosis-target registration terminal 13 and the recommended information registration terminal 14 are communicably connected to the Web server. When the diagnostic service provider registers each one of the above described information, the diagnosis data management terminal 10, the biomarker data registration terminal 11, the life log data registration terminal 12, the diagnosis-target registration terminal 13, and the recommended information registration terminal 14 access the Web server. The database management apparatus 30 stores various data transmitted from the Web server in the databases. Instead of the Web server, a file transfer protocol (FTP) server can be used, in which any communication protocol can be used. Further, the Web server can be configured by the database management apparatus 30.

The risk value calculation terminal 50 is located where the diagnosis-target person or the concerned party/person can operate the risk value calculation terminal 50 because the diagnosis-target person or the concerned party/person may frequently operate the risk value calculation terminal 50. When the risk value calculation terminal 50 accesses the Web server, and requests a risk value calculation, the Web server transmits the risk value calculated by the risk value calculation apparatus 60 to the risk value calculation terminal 50.

The history management apparatus 40 may be placed at a location under the control of the diagnostic service provider or placed at a location where the diagnosis-target person or the concerned party/person can use. When the diagnosis-target person or the concerned party/person delegates administration of management of the diagnosis-target data to the diagnostic service provider, the history management apparatus 40 is placed at a location where the diagnostic service provider can access the history management apparatus 40. Since the diagnosis-target data includes privacy information, when the diagnosis-target person or the concerned party/person manages the history management apparatus 40, the history management apparatus 40 is placed at a location where the diagnosis-target person or the concerned party/person alone can access the history management apparatus 40.

### (Hardware Configuration)

FIG. 3 illustrates an example of a hardware block diagram of the terminals and the apparatuses. As described above, each of the terminals and the apparatuses can be used as an information processing apparatus. Each of the terminals and the apparatuses includes, for example, a central processing unit (CPU) 301, a read only memory (ROM) 302, a random access memory (RAM) 303, and an auxiliary storage device 304. Each of the terminals and the apparatuses further includes, for example, an input unit 305, a display interface (I/F) 306, a network interface (I/F) 307, and an external device interface (I/F) 308. Further, each of the units in each of the terminals and the apparatuses are connected with each other via a bus B.

The CPU 301 executes various programs such as a program 304p, and an operating system (OS) stored in the auxiliary storage device 304. The ROM 302 is a non-volatile memory, and the ROM 302 stores a system loader and various data.

The RAM 303 is a main storage device such as dynamic random access memory (DRAM) and static random access memory (SRAM). The program 304 p stored in the auxiliary storage device 304 is loaded on the RAM 303 when executed by the CPU 301, and the RAM 303 serves as a working area of the CPU 301.

The auxiliary storage device 304 stores the program 304p to be executed by the CPU 301, and various databases to be used when the program 304p is executed by the CPU 301. The auxiliary storage device 304 is, for example, a non-volatile memory such as a hard disk drive (HDD) and a solid state drive (SSD).

The input unit 305 is an interface used by an operator to input various instructions to the terminals and the apparatuses. The input unit 305 is, for example, a keyboard, a mouse, a touch panel, and a voice input device. The input unit 305 is disposed if necessary.

Based on a request from the CPU 301, the display I/F 306 displays various information used for the terminals and the apparatuses on a display 310, which is a display device, in the form of a cursor, a menu, a window, character, or image. The display I/F 306 is, for example, a graphic chip or the display interface. The display I/F 306 is disposed if necessary.

The network I/F 307 is a communication device that communicates with another terminal and/or apparatus via a network, and the network I/F 307 is, for example, Ethernet (registered trademark) card, but not limited thereto.

The external device I/F 308 is an interface for connecting with a universal serial bus (USB) cable or a recording medium 320 such as a USB memory. The recording medium 320 may be also referred to as the storage medium.

The hardware configuration of FIG. 3 is an example, and a hardware configuration such as a smartphone can be employed in some cases. For example, in case of using a smartphone running application software for the risk value calculation terminal 50, the diagnosis-target person or the concerned party/person access the risk value calculation apparatus 60 from the risk value calculation terminal 50, and then the calculated risk value can be displayed on the risk value calculation terminal 50 such as the smartphone.

### (Function of Diagnostic System)

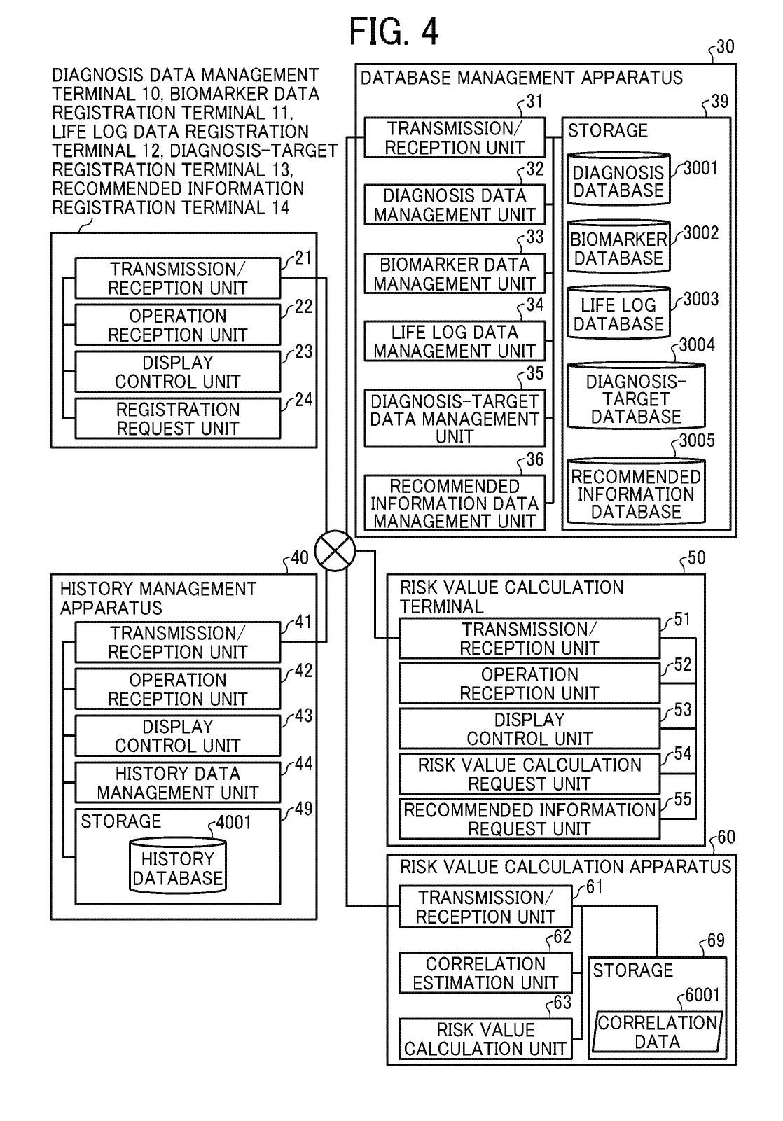

FIG. 4 illustrates an example of a functional block diagram of the terminals and the apparatuses employed in the diagnostic system 100.

A description is given of the diagnosis data management terminal 10, the biomarker data registration terminal 11, the life log data registration terminal 12, the diagnostic-target registration terminal 13, and the recommended information registration terminal 14 with reference to FIG. 4.

As illustrated in FIG. 4, each of the diagnosis data management terminal 10, the biomarker data registration terminal 11, the life log data registration terminal 12, the diagnosis-target registration terminal 13, and the recommended information registration terminal 14 includes, for example, a transmission/reception unit 21, an operation reception unit 22, a display control unit 23, and a registration request unit 24. Each of these functional units can be implemented when at least any one of the components configuring the terminal or apparatus illustrated in FIG. 3 is operated by a command from the CPU 301 when the CPU 301 executes the program 304p loaded on the RAM 303 from the auxiliary storage device 304.

The transmission/reception unit 21 can be implemented when the CPU 301 (FIG. 3) executes the program 304p and controls the network I/F 307, and the transmission/reception unit 21 performs communication of various data mainly with the database management apparatus 30 via the network N.

The operation reception unit 22 can be implemented when the CPU 301 (FIG. 3) executes the program 304p and controls the input unit 305, and the operation reception unit 22 receives an input of operation and information to the terminal or the apparatus.

The display control unit 23 can be implemented when the CPU 301 (FIG. 3) executes the program 304p and controls the display I/F 306, and the display control unit 23 displays various screens on the display 310. For example, the display control unit 23 interprets HyperText Markup Language (HTML) data and script language for displaying a data registration screen, and then displays a Web page. Alternatively, when dedicated application software programs are running on these terminals or apparatuses, the data registration screen is displayed by setting parts of the screen at various positions on the display.

The registration request unit 24 can be implemented when the CPU 301 (FIG. 3) executes the program 304p, and the registration request unit 24 requests registration of various data input by the diagnostic service provider to the database management apparatus 30 through the transmission/reception unit 21.

### (Database Management Apparatus)

As illustrated in FIG. 4, the database management apparatus 30 includes, for example, a transmission/reception unit 31, a diagnosis data management unit 32, a biomarker data management unit 33, a life log data management unit 34, a diagnosis-target data management unit 35, and a recommended information data management unit 36. Each of these functional units can be implemented when at least any one of the components configuring the terminal or apparatus illustrated in FIG. 3 is operated by a command from the CPU 301 when the CPU 301 executes the program 304p loaded on the RAM 303 from the auxiliary storage device 304.

Further, the database management apparatus 30 includes, for example, a storage 39 that can be implemented by the RAM 303 and/or the auxiliary storage device 304, and the storage 39 stores various information. For example, the storage 39 stores a diagnosis database 3001, a biomarker database 3002, a life log database 3003, a diagnosis-target database 3004, and a recommended information database 3005. A description is given of these databases in the below description.

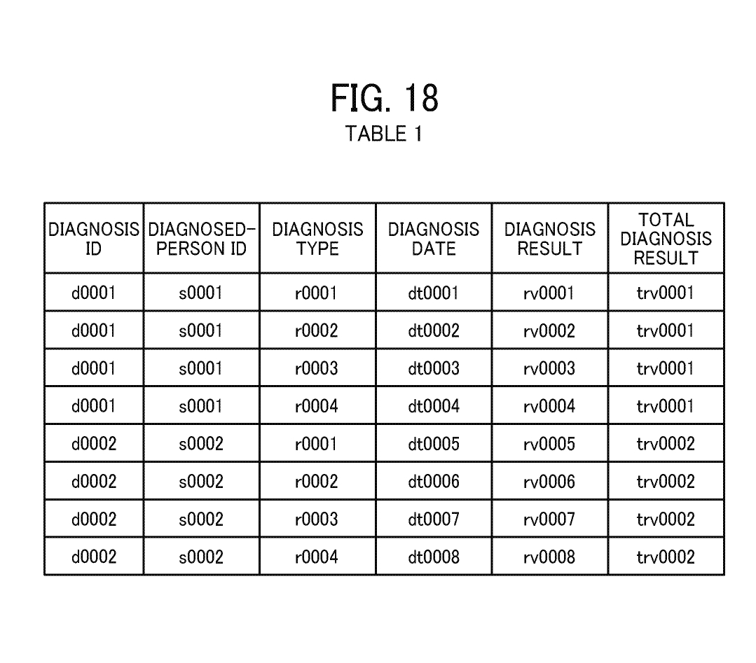

Table 1, illustrated as FIG. 18, is an example of data registered in the diagnosis database 3001, in which the data are registered with a table-formatted data. The diagnosis database 3001 stores information of diagnosis results of persons such as depression patients and healthy persons. The diagnosis database 3001 employs, for example, a table-formatted database, and the diagnosis database 3001 includes a set of a plurality of records recording a plurality of diagnosis results. As illustrated in Table 1 (FIG. 18), each one of the records includes, for example, six attribute information (or fields, items) such as diagnosis identification (ID), diagnosed-person identification (ID), diagnosis type, diagnosis date, diagnosis result, and total diagnosis result.

The diagnosis ID indicates information for specifying one diagnosis for one depression patient or one healthy person, and the diagnosis ID may be referred to as identification information for uniquely identifying each of the diagnosis. The ID can be set as a combination of name, code, character string, numerical value or the like, which is used for uniquely distinguishing a specific target from a plurality of targets. In this description, other IDs are set similar to the diagnosis ID.

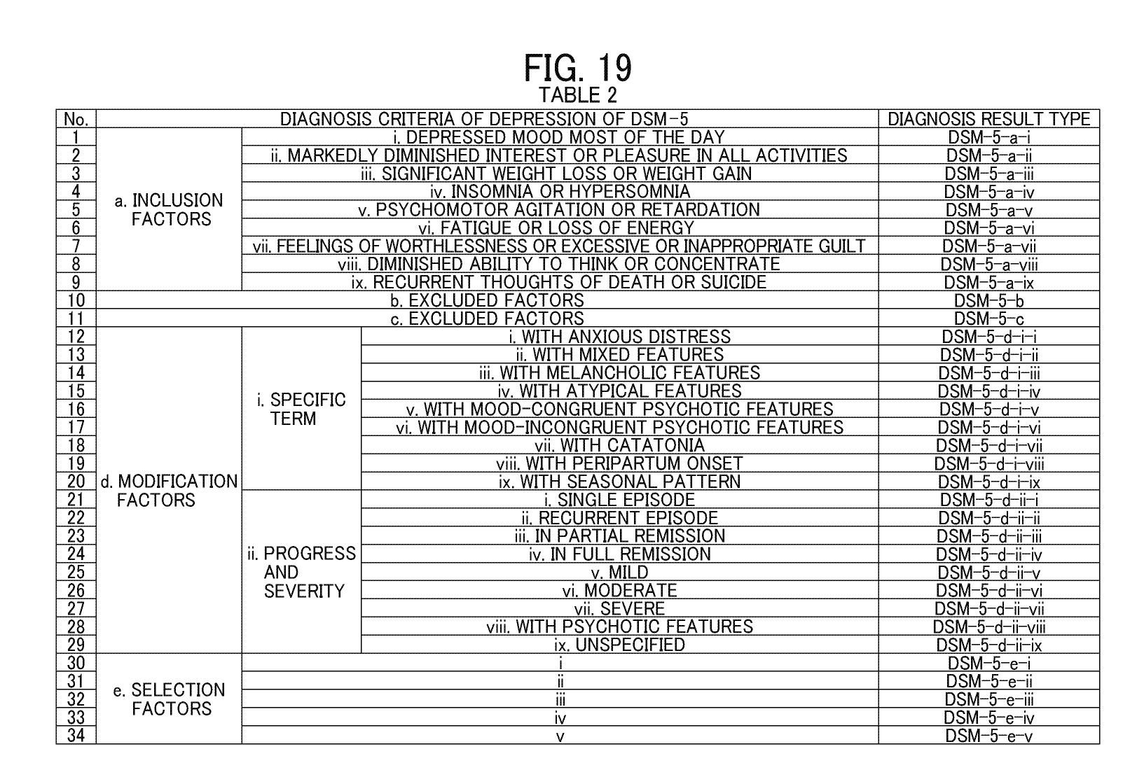

The diagnosed-person ID indicates information for identifying each of the diagnosed depression patient or healthy person or information for uniquely identifying each of the diagnosed depression patient or the healthy person. The diagnosis type represents a diagnosis item that is used a reference for the diagnosis among a plurality of diagnosis items. The diagnosis type is defined by medical standards such as “ICD-10” of the International Classification of Diseases (ICD) of World Health Organization (WHO), “DSM-5” of American Psychiatric Association (APA) or the like. Table 2, illustrated as FIG. 19, lists the diagnosis types of DSM-5.

The diagnosis date represents a diagnosis-performed date for each of the diagnosis types, in which the diagnosis date includes, for example, year, month, day, and time. The diagnosis result is a value of the performed-diagnosis for each of diagnosis types. The value is set, for example, “1 or 0” depending on whether each of the diagnosis types is positive or negative. The total diagnosis result indicates that a person is diagnosed as a depression patient or a healthy person for one diagnosis process. Therefore, the diagnosis type represents the diagnosis item, and the diagnosis result indicates whether the condition of the diagnosed person matches the concerned diagnosis item. For example, as to the diagnosis type of No. 1 in Table 2 (FIG. 19), the diagnosis result is obtained as a “Yes or No” answer of person (e.g., depression patient, healthy person) to the diagnosis type of No. 1 “depressed mood most of the day.” Further, a doctor can determine the total diagnosis result by collecting answers to each of the diagnosis types.

Table 2 (FIG. 19) illustrates the diagnostic criteria and diagnosis result types of “DSM-5,” which is one of the diagnostic criteria of the depression symptoms. In DSM-5, each the diagnosis result types is classified into an inclusion factor, an excluded factor, a modification factor, and a selection factor. The diagnostic criteria stored in the diagnosis database 3001 represents what kind of diagnosis is performed in each of the elements of the inclusion factor, the excluded factor, the modification factor, and the selection factor, and the diagnosis result types stored in the diagnosis database 3001 represents a diagnosis result for each of the elements by setting a value. Since the DSM-5 has 34 diagnosis types, when one diagnosis is performed, 34 records are generated for one depression patient or healthy person, and stored in the diagnosis database 3001. For example, the first record of the diagnosis type corresponds to “DSM-5-a-i,” and a diagnosis result value of the first record represents a value of “1 or 0” to indicate whether a person is “depressed mood most of the day.” The detail of DSM-5 can be obtained from the publicly available sources. Since the diagnostic criteria of the depression symptoms is still under the research, the diagnosis result types may increase or decrease in the future.

Further, although Table 2 (FIG. 19) illustrates the DSM-5, when the diagnostic criteria is revised and the diagnostic criteria such as DSM-6 is created in future, the embodiment can be performed also based on the revised diagnostic criteria.

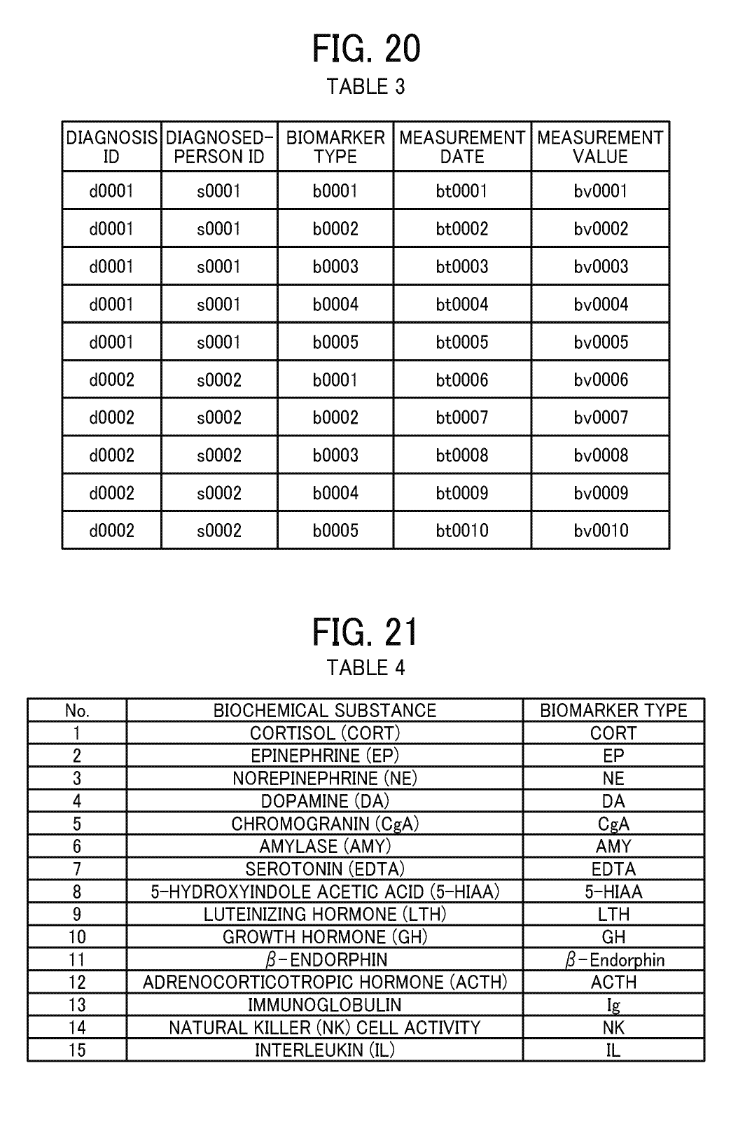

Table 3, illustrated as FIG. 20, is an example of data registered in the biomarker database 3002, in which the data are registered with a table-formatted data. The biomarker database 3002 stores measurement values of the biomarker of persons such as depression patients and healthy persons. The biomarker database 3002 employs, for example, a table-formatted database, and the biomarker database 3002 includes a set of a plurality of records recorded for a plurality of biomarker data respectively, in which one record is recorded for one biomarker.

As illustrated in Table 3 (FIG. 20), each one of the records includes, for example, five attribute information such as diagnosis ID, diagnosed-person ID, biomarker type, measurement date, and measurement value. The diagnosis ID represents a specific diagnosis corresponding to a specific biomarker. For example, each one of the depression patients or the healthy persons are diagnosed by a doctor, and also inspected by using the biomarker at the same time diagnosis. Then, the measurement value of the biomarker and the diagnosis by the doctor performed at the same time diagnosis are linked by the diagnosis ID.

The diagnosed-person ID of Table 3 (FIG. 20) is same as the diagnosed-person ID of Table 1 (FIG. 18). The biomarker type represents one of a plurality of the biomarkers. An example of the biomarkers is illustrated in Table 4 (FIG. 21). The measurement date represents date (including year, month, day, and time) when the biomarker was measured. The measurement value represents a value of the biomarker that was measured. As illustrated in Table 3 (FIG. 20), the measurement value of one biomarker type is linked by the diagnosis ID.

Table 4, illustrated as FIG. 21, is an example the biomarker types. It is known that stress is one of the causes of the depression. The biomarkers (or stress markers) that may be correlated with the magnitude of stress received by the depression patients or the healthy persons includes, for example, biochemical substances illustrated in Table 4. Table 4 lists, for example, 15 biomarkers. Since the biomarker effective for diagnosing the depression symptom is still under the research, these biomarkers may increase or decrease in the future.

When the stress markers listed in Table 4 (FIG. 21) are employed as the biomarkers of the depression symptom, 15 records are registered in the biomarker database 3002 for one inspection. The biomarker types stored in the biomarker database 3002 represent biochemical substances used as these stress markers, and one measurement value of the biomarker data represents a measured value of a specific biochemical substance. The types of biomarkers can be found in publicly-available information sources.

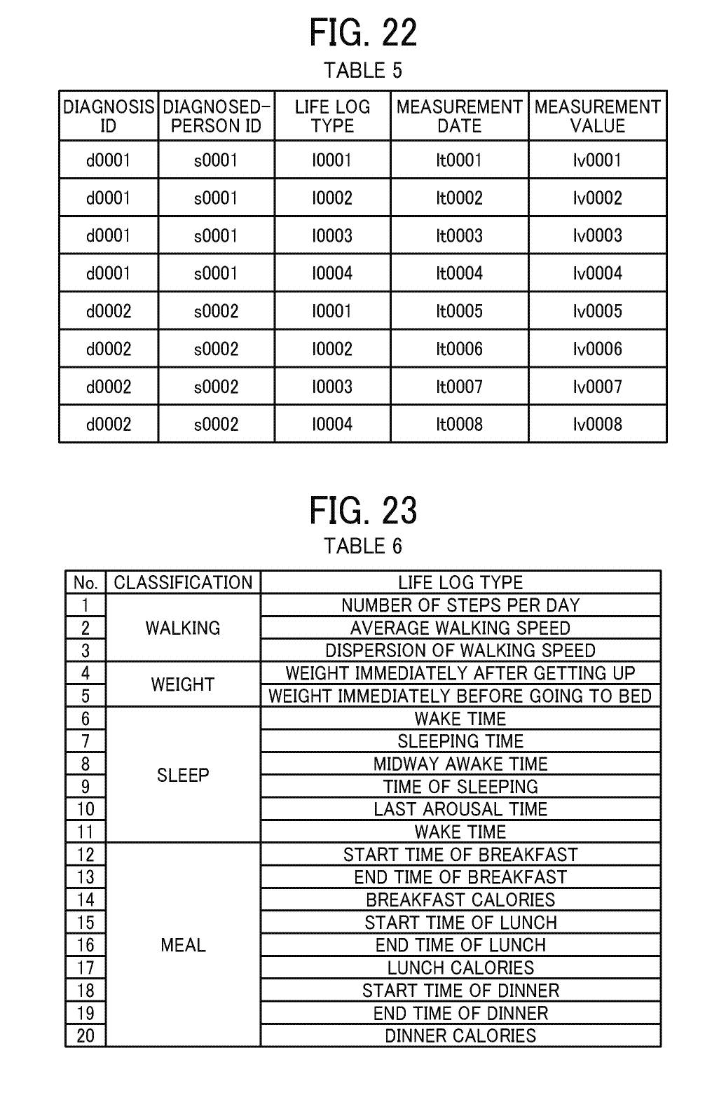

Table 5, illustrated as FIG. 22, is an example of data registered in the life log database 3003, in which the data are registered with a table-formatted data. The life log database 3003 can be also referred to as a life pattern database. The life log database 3003 stores the life log data of persons such as depression patients and healthy persons. The life log database 3003 employs, for example, a table-formatted database, and the life log database 3003 includes a set of a plurality of records recorded for a plurality of the life log types, in which one record is generated for one life log type.

As illustrated in Table 5 (FIG. 22), each one of the records includes, for example, five attribute information such as diagnosis ID, diagnosed-person ID, life log type, measurement date, and measurement value. The diagnosis ID is used to link the life log type and the diagnosis result. The life log types accumulated for one person until the person is diagnosed by a doctor is linked to one diagnosis ID. The diagnosed-person ID and the measurement date stored in life log database 300 are same as the diagnosed-person ID and the measurement date stored in the diagnosis database 3001. The measurement value represents a value measured for a specific life log type. Further, Table 6 (FIG. 23) illustrates an example of the life log types.

Table 6 illustrated as FIG. 23, is an example of the life log types stored or registered in the life log database 3003. The life log types listed in Table 6 are classified into, for example, walking, weight, sleep, and meal, and life log types are registered for each one of classifications. In an example case of Table 6, 20 life log types are registered.

The depression patients, the healthy persons, and the diagnosis-target persons record these life log types every day, and when a doctor diagnoses the depression patients, the healthy persons, and the diagnosis-target persons for once per month, a set of record including 20 records per day for one month is registered in the life log database 3003. The life log types set in the life log database 3003 match the life log types set in Table 6 (FIG. 23), and the measurement value of the life log data represents a value measured for a specific life log type.

Further, the life log types having higher correlation with the depression symptom are not limited to the life log types listed in the Table 6. For example, the life log types having higher correlation with the depression symptom may further include heart rate, blood glucose level, blood pressure, and electroencephalogram in addition to the life log types listed in the Table 6.

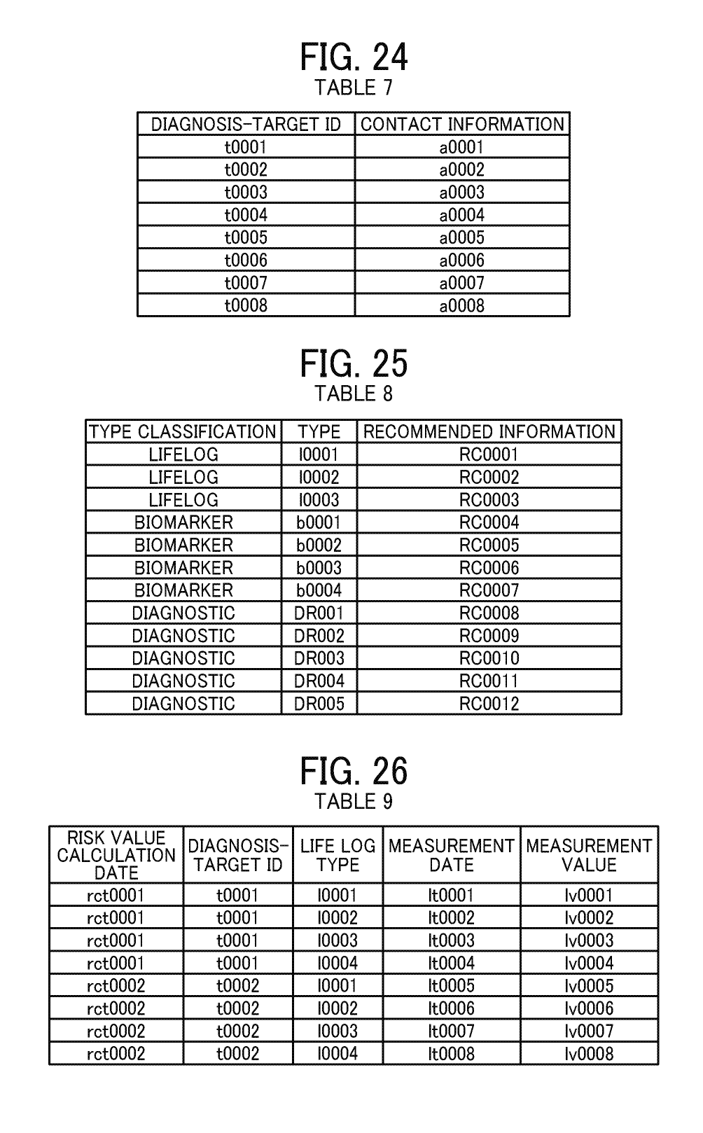

Table 7, illustrated as FIG. 24, is an example of data registered in the diagnosis-target database 3004, in which the data are registered with a table-formatted data. The diagnosis-target database 3004 stores information related to the diagnosis-target person. The diagnosis-target database 3004 employs, for example, a table-formatted database, and the diagnosis-target database 3004 includes a set of a plurality of records recorded for a plurality of the registered diagnosis-target persons, in which one record is set for one diagnosis-target person. As illustrated in Table 7, each one of the records includes, for example, two attribute information such as diagnosis-target ID, and contact information.

The diagnosis-target ID is information used for identifying the registered diagnosis-target person or uniquely identifying the registered diagnosis-target person, and the contact information represents a communication method and destination for communicating information to the diagnosis-target person. The contact information stores for example, e-mail address, telephone number, and address.

Table 8, illustrated as FIG. 25, is an example of data registered in the recommended information database 3005, in which the data are registered with a table-formatted data. The recommended information database 3005 stores the recommended information for the diagnosis-target person. The recommended information database 3005 employs, for example, a table-formatted database, and the recommended information database 3005 includes a set of a plurality of records recording a plurality of the recommended information, which may be suitable for the diagnosis-target person for each one of the records.

As illustrated in Table 8 (FIG. 25), each one of the records includes, for example, three attribute information such as type classification, type, and recommended information. The type classification represents, for example, LIFELOG, BIOMARKER, and DIAGNOSTIC. The type represents the life log type, the biomarker type, and the diagnosis type. The recommended information represents recommended information associated to each one of the types related to the diagnosis-target person. For example, when the type classification is LIFELOG, the recommended information is a measurement of the number of steps by an activity meter (e.g., increase of the number of steps of walking), when the type classification is BIOMARKER, the recommended information is a blood inspection (e.g., alert on blood constituents), and when the type classification is DIAGNOSTIC, the recommended information is related to food (e.g., food to be ingested).

In addition, the recommended information can include various information such as sports (e.g., yoga), sleeping time to be satisfied, suggestions of books, movies, music, and human relation seminars, which can be useful information for improving the depression symptom.

### (Function of Database Management Apparatus)

As to the database management apparatus 30, the transmission/reception unit 31 can be implemented when the CPU 301 (FIG. 3) executes the program 304p and controls the network I/F 307, and the transmission/reception unit 31 performs communication of various data with the diagnosis data management terminal 10, the biomarker data registration terminal 11, the life log data registration terminal 12, the diagnosis-target registration terminal 13, the recommended information registration terminal 14, the risk value calculation terminal 50, and the risk value calculation apparatus 60 via the network N.

As to the database management apparatus 30, the diagnosis data management unit 32 can be implemented when the CPU 301 (FIG. 3) executes the program 304p, and the diagnosis data management unit 32 receives a registration of diagnosis data transmitted from the diagnosis data management terminal 10, and registers the diagnosis data transmitted from the diagnosis data management terminal 10 to the diagnosis database 3001. Further, in response to a request from the risk value calculation apparatus 60, the diagnosis data management unit 32 reads out the diagnosis data from the diagnosis database 3001, and transmits the diagnosis data to the risk value calculation apparatus 60 through the transmission/reception unit 31.

As to the database management apparatus 30, the biomarker data management unit 33 can be implemented when the CPU 301 (FIG. 3) executes the program 304p, and the biomarker data management unit 33 receives a registration of biomarker data transmitted from the biomarker data registration terminal 11, and registers the biomarker data transmitted from the biomarker data registration terminal 11 to the biomarker database 3002. Further, in response to a request from the risk value calculation apparatus 60, the biomarker data management unit 33 reads out the biomarker data from the biomarker database 3002, and transmits the biomarker data to the risk value calculation apparatus 60 through the transmission/reception unit 31.

As to the database management apparatus 30, the life log data management unit 34 can be implemented when the CPU 301 (FIG. 3) executes the program 304p, and the life log data management unit 34 receives a registration of the life log data transmitted from the life log data registration terminal 12, and registers the life log data transmitted from the life log data registration terminal 12 to the life log database 3003. Further, in response to a request from the risk value calculation apparatus 60, the life log data management unit 34 reads out the life log data from the life log database 3003, and transmits the life log data to the risk value calculation apparatus 60 through the transmission/reception unit 31.

As to the database management apparatus 30, the diagnosis-target data management unit 35 can be implemented when the CPU 301 (FIG. 3) executes the program 304p, and the diagnosis-target data management unit 35 receives a registration of diagnosis-target data transmitted from the diagnosis-target registration terminal 13, and registers the diagnosis-target data transmitted from the diagnosis-target registration terminal 13 to the diagnosis-target database 3004. Further, in response to a request from the history management apparatus 40, the diagnosis-target data management unit 35 reads out the diagnosis-target data from the diagnosis-target database 3004, and transmits the diagnosis-target data to the history management apparatus 40 through the transmission/reception unit 31.

As to the database management apparatus 30, the recommended information data management unit 36 can be implemented when the CPU 301 (FIG. 3) executes the program 304p, and the recommended information data management unit 36 receives a registration of recommended information transmitted from the recommended information registration terminal 14, and registers the recommended information transmitted from the recommended information registration terminal 14 to the recommended information database 3005. Further, in response to a request from the risk value calculation terminal 50, the recommended information data management unit 36 reads out the recommended information from the recommended information database 3005, and transmits the recommended information to the risk value calculation terminal 50 through the transmission/reception unit 31.

### (History Management Apparatus)

As illustrated in FIG. 3, the history management apparatus 40 includes, for example, a transmission/reception unit 41, an operation reception unit 42, a display control unit 43, and a history data management unit 44. Each of these functional units can be implemented when at least any one of the components configuring the terminal or apparatus illustrated in FIG. 3 is operated by a command from the CPU 301 when the CPU 301 executes the program 304p loaded on the RAM 303 from the auxiliary storage device 304.

Further, the history management apparatus 40 includes, for example, a storage 49 that can be implemented by the RAM 303 and/or the auxiliary storage device 304, and the storage 49 stores various information. For example, the storage 49 stores a history database 4001. A description is given of the history database 4001 in the below description.

Table 9, illustrated as FIG. 26, is an example of data registered in the history database 4001, in which the data are registered with a table-formatted data. The history database 4001 stores the life log data of the diagnosis-target person.

The history database 4001 employs, for example, a table-formatted database, and the history database 4001 includes a set of a plurality of records for a plurality of the life log types of a plurality of the diagnosis-target persons. As illustrated in Table 9 (FIG. 26), each one of the record includes, for example, five attribute information such as risk value calculation date, diagnosis-target ID, life log type, measurement date, and measurement value. One risk value calculation date is set for all of the life log types input per one-time registration (e.g., 20 records per day×one month).

The risk value calculation date represents date (including year, month, day, and time) when the diagnosis-target person or the concerned party/person calculated the risk value of the depression symptom of the diagnosis-target person. The diagnosis-target ID registered in the history database 4001 (Table 9) is same as the diagnosis-target ID registered in the diagnosis-target database 3004. The life log type, the measurement date, and the measurement value registered in the history database 4001 (Table 9) are same as the life log type, the measurement date, and the measurement value registered in the life log database 3003. Table 9 (FIG. 26) does not include the estimated risk value, but the estimated risk value can be included in Table 9. However, the risk value calculation apparatus 60 can calculate the risk value from the life log type and the measurement value if necessary.

When the diagnosis data and the biomarker data are changed, different risk values may be calculated for the same the life log data because the correlation may be also changed. Therefore, the risk value calculation apparatus 60 preferably calculates the risk value with the current correlation.

As to the history management apparatus 40, the transmission/reception unit 41, the operation reception unit 42 and the display control unit 43 can be implemented similar to the diagnosis data management terminal 10 or the like. The history data management unit 44 can be implemented when the CPU 301 (FIG. 3) executes the program 304p. When the risk value calculation terminal 50 receives a request for calculating a risk value from the diagnosis-target person or the concerned party/person, the risk value calculation terminal 50 registers the diagnosis-target ID and the life log data, input by the diagnosis-target person or the concerned party/person, with the calculation request, to the history database 4001. The risk value calculation apparatus 60 acquires diagnosis data, biomarker data, and life log data to be used for calculating the correlation data 6001 from the database management apparatus 30. The risk value calculation terminal 50 acquires the recommended information associated to the life log data, an estimation value of the biomarker data, and an estimation value of the diagnosis data of the diagnosis-target person from the database management apparatus 30. Each of the risk value calculation apparatus 60 and the risk value calculation terminal 50 acquires each of the attribute information used for calculating the risk value of the diagnosis-target person from the database management apparatus 30.

### (Risk Value Calculation Terminal)

As illustrated in FIG. 3, the risk value calculation terminal 50 includes, for example, a transmission/reception unit 51, an operation reception unit 52, a display control unit 53, a risk value calculation request unit 54, and a recommended information request unit 55. Each of these functional units can be implemented when at least any one of the components configuring the terminal or apparatus illustrated in FIG. 3 is operated by a command from the CPU 301 when the CPU 301 executes the program 304p loaded on the RAM 303 from the auxiliary storage device 304.

The transmission/reception unit 51, the operation reception unit 52, and the display control unit 53 of the risk value calculation terminal 50 can be implemented similar to the diagnosis data management terminal 10 or the like. The risk value calculation request unit 54 can be implemented when the CPU 301 (FIG. 3) executes the program 304p. When the diagnosis-target person or the concerned party/person requests a calculation of the risk value of the diagnosis-target person, the risk value calculation request unit 54 transmits a calculation request of the risk value to the risk value calculation apparatus 60 through the transmission/reception unit 51.

The display control unit 53 of the risk value calculation terminal 50 acquires the risk value calculated by the risk value calculation apparatus 60, and displays the risk value on the display 310.

The recommended information request unit 55 can be implemented when the CPU 301 (FIG. 3) executes the program 304p. The recommended information request unit 55 requests the recommended information associated to life log data, an estimation value of the biomarker data, and an estimation value of the diagnosis data of the diagnosis-target person to the database management apparatus 30 through the transmission/reception unit 51.

### (Risk Value Calculation Apparatus)

As illustrated in FIG. 3, the risk value calculation apparatus 60 includes, for example, a transmission/reception unit 61, a correlation estimation unit 62, and, a risk value calculation unit 63. Each of these functional units can be implemented when at least any one of the components configuring the terminal or apparatus illustrated in FIG. 3 is operated by a command from the CPU 301 when the CPU 301 executes the program 304p loaded on the RAM 303 from the auxiliary storage device 304.

Further, the risk value calculation apparatus 60 includes, for example, a storage 69 that can be implemented by the RAM 303 and/or the auxiliary storage device 304, and the storage 69 stores various information. The storage 69 stores correlation data 6001. The correlation data 6001 represents data defining correlation of the life log data and the biomarker data, and correlation of the biomarker data and the diagnosis data.

The correlation estimation unit 62 can be implemented when the CPU 301 (FIG. 3) executes the program 304p, and the correlation estimation unit 62 calculates the above described correlation by using the diagnosis data, the biomarker data, and the life log data stored in the database management apparatus 30.

The risk value calculation unit 63 can be implemented when the CPU 301 (FIG. 3) executes the program 304p, and the risk value calculation unit 63 calculates the risk value of the diagnosis-target person by using the correlation data 6001.

### (Correlation)

### (Calculation of Correlation by Regression)

The prediction of a value of a target variable T from a value of an input variable such as a vector X is known as the regression problem. The goal of the regression problem is to predict a value of T for a measurement value X when training data composed with target values {Tn} corresponding to “N” observations such as {Xn} (n=1 to N) is given. As a simple solution, a function T=f(X) for input X is to be obtained. The simplest linear regression model of the function “f” is a linear combination of the input variables. The regression problem can be solved by using known methods. In this description, “T” is set as below.

T=a1·x1+a2·x2+a3·x3+a4·x4+ . . . +an·x20

The concept of the regression problem is applied to the embodiment. For the sake of convenience of description, a correlation estimation method of FIG. 1A will be described, but the estimation method of FIG. 1B can be also performed with the same manner.

Hereinafter, the diagnosis data using each of the diagnosis results as the element is set as a vector D, the biomarker data using each of the measurement values as the element is set as a vector B, and the life log data using each of the measurement values as the element is set as a vector L. In the example case in this description, the total element number of the diagnosis data is 34 as illustrated in Table 2 (FIG. 19), the total element number of the biomarker data is 15 as illustrated in Table 4 (FIG. 21), and the total element number of the life log data is 20 as illustrated in Table 6 (FIG. 22).

In this description, the biomarker data is estimated from the life log data, in which it is assumed that one element of the biomarker data is linked to 20 elements of the life log data. In this description, a function for calculating the biomarker data of persons such as depression patients and healthy persons from the life log data of persons such as depression patients and healthy persons is referred to “L to B.” When each element of the life log data is represented by L1 to L20, and each element of the biomarker data is represented by B1 to B15, the linear combination of “L to B” can be expressed as below.

L to B1=a1·L1+a2·L2+a3·L3+a4·L4+ . . . +a20·L20

In this expression, each of “a1” to “a20” is a coefficient of each element of the life log data. Therefore, when the regression problem is solved by using the training data of the depression patients and the healthy persons to calculate “a1” to “a20,” the life log data and the biomarker data can be expressed by the linear combination. The regression problem can be solved, for example, by the least squares method.

Further, the similar calculation is performed for each of the elements of the biomarker data as indicated by the following expression (1) set for “L to B1 to “L to B15.”

L to B2=b1·L1+b2·L2+b3·L3+b4·L4+ . . . +b20·L20

L to B3=c1·L1+c2·L2+c3·L3+c4·L4+ . . . +c20·L20
(Expressions of “L to B4” to “L to B14” are omitted)

L to B15=o1·L1+o2·L2+o3·L3+o4·L4+ . . . +o20·L20 (1)

Further, the diagnosis data is estimated from the biomarker data, in which it is assumed that one element of the diagnosis data is linked to 15 elements of the biomarker data. In this description, a function for calculating the diagnosis data of persons such as depression patients and healthy persons from the biomarker data of persons such as depression patients and healthy persons is referred to “B to D.” When each element of the biomarker data is represented by B1 to B15, and each element of the diagnosis data is represented by D1 to D34, the linear combination of “B to D” can be expressed as indicated by the following expression (2), in which coefficients “a1” to a15” or the like are different from the coefficients used in the expression (1).

B to D1=a1·B1+a2·B2+a3·B3+a4·B4+ . . . +a15·B15

B to D2=b1·B1+b2·B2+b3·B3+b4·B4+ . . . +b15·B15
(Expressions of “B to D3” to “B to D33” are omitted)

B to D34=hh1·B1+hh2·B2+hh3·B3+hh4·B4+ . . . +hh15·B15 (2)

Therefore, the correlation estimation unit 62 can determine the coefficients by referring the diagnosis database 3001 storing the diagnosis data of the depression patients and the healthy persons, the life log database 3003 storing the life log data of the depression patients and the healthy persons, the biomarker database 3002 storing the biomarker data of the depression patients and the healthy persons. Then, the correlation estimation unit 62 stores the determined coefficients in the storage 69 as the correlation data 6001.

Similarly, when the life log data of the diagnosis-target person is set as a vector L′, an estimation value of the biomarker data of the diagnosis-target person is set as a vector B′, and an estimation value of the diagnosis data of the diagnosis-target person is set as a vector D′, the following relationship can be obtained.
L′ to B′
B′ to D′

The risk value calculation unit 63 applies the expression (1) for L′ to B′, and substitutes the life log data of the diagnosis-target person in the expression (1) to estimate the biomarker data of the diagnosis-target person. Further, the risk value calculation unit 63 applies the expression (2) for B′ to D′, and substitutes the biomarker data of the diagnosis-target person in the expression (2) to estimate the diagnosis data of the diagnosis-target person.

Further, in the embodiment, the life log data, the biomarker data, and the diagnosis data of the depression patients and the healthy persons are not distinguished. However, if correlation between data and the depression patients and correlation of data between the healthy persons are both calculated by the above regression method, the biomarker data and the diagnosis data of the diagnosis-target person can be estimated and then the diagnosis-target person can be determined as the depression patient or the healthy person even if the diagnosis-target person is not known as the depression patient or the healthy person.

Further, although the diagnosis data takes a value in a range from 0 to 1 for each attribute information, the risk level of the depression is not necessarily higher when the diagnosis data is closer to 1. For example, when one of the diagnostic criteria such as “modification factor/progress and severity/severe” is closer to 1, the diagnosis-target person is presumed to have a higher risk level of the depression symptom, but when one of the diagnostic criteria such as “modification factor/progress and severity/mild” is closer to 1, the diagnosis-target person is presumed to have a lower risk level of the depression symptom. Further, as to other attribute information of the diagnostic criteria, the higher risk level or lower risk level of the depression symptom varies depending on each of attribute information.

Therefore, the risk value calculation unit 63 calculates the risk value by applying a weight to each of the attribute information of the diagnosis data. Specifically, the risk value calculation unit 63 sets a weight to each of 34 attribute information, calculates the risk value by applying the weight to each of estimation results of 34 attribute information, and then totals the estimation results of 34 attribute information, in which the greater the risk value, the greater the risk level of the depression symptom can be set. Further, the diagnosis data itself can be used as the risk value.

With this configuration, the diagnosis-target person can estimate the biomarker data and the diagnosis data without going to a medical institution, and thereby the early diagnosis of the depression symptom can be performed.

Further, the risk value calculation unit 63 can estimate the biomarker data and the diagnosis data of the diagnosis-target person based on the life log data of the diagnosis-target person obtained at different date. Therefore, the diagnosis-target person or the concerned party/person can check an increase or decrease trend of the risk value, the biomarker data, and the diagnosis data of the diagnosis-target person, and can check whether the diagnosis-target person may likely becomes the depression symptom or may be improving.

Further, although the linear combination is described in the embodiment, the coefficients can be calculated by applying the regression to a second or higher order polynomial.

### (Estimation by Machine Learning)

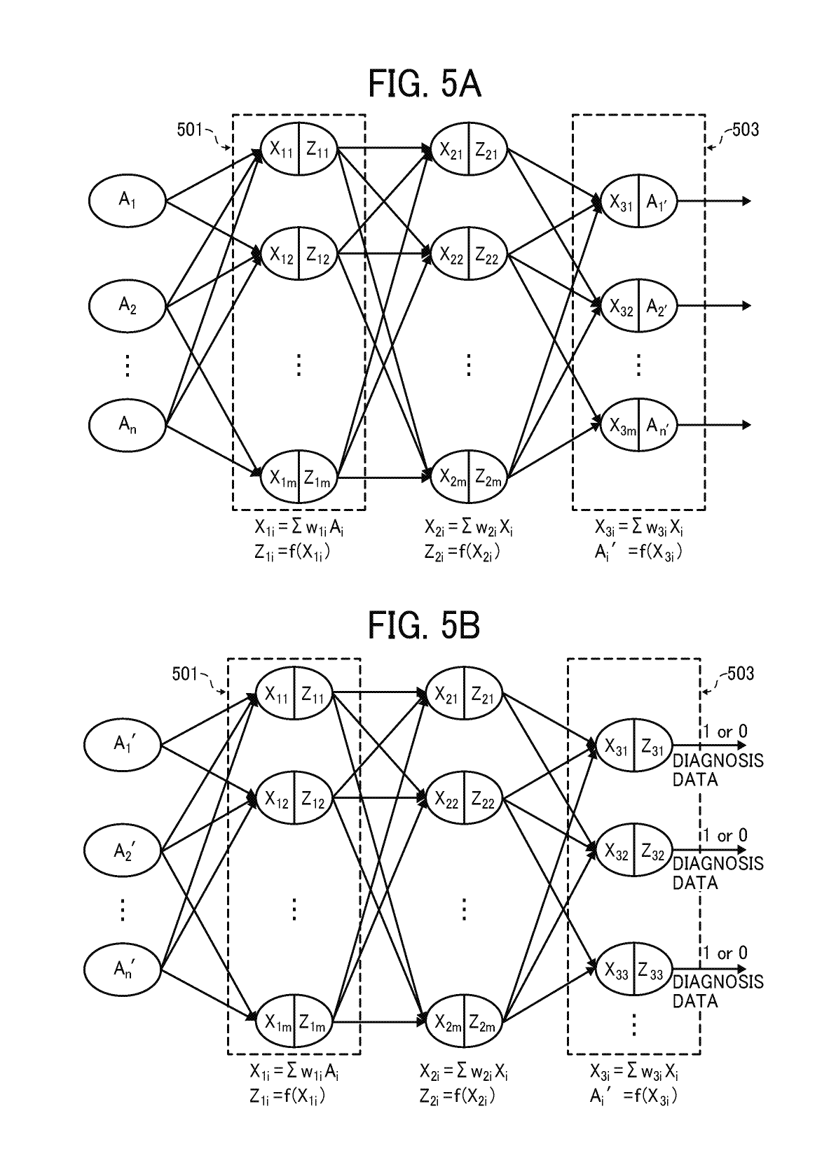

Further, the correlation can be calculated by a machine learning. FIG. 5 illustrates an example configuration of a neural network used as one example model of the machine learning. FIG. 5A illustrates a neural network that outputs biomarker data from life log data, in which the life log data (e.g., L1 to L20) of persons such as depression patients and healthy persons are input to an input layer 501, and the biomarker data (e.g., B1 to B15) of persons such as depression patients and healthy persons are output from an output layer 503. Therefore, in a case of FIG. 5A, the number of nodes of the input layer 501 corresponds to the number of types of the life log data, and the number of nodes of the output layer 503 corresponds to the number of types of the biomarker data. The number of the intermediate layers is set one, but the number of the intermediate layers can be set differently as required.

FIG. 5B illustrates a neural network that outputs diagnosis data from biomarker data, in which the biomarker data (e.g., B1 to B15) of persons such as depression patients and healthy persons are input to the input layer 501, and the diagnosis data (e.g., D1 to 34) of persons such as depression patients and healthy persons are output from the output layer 503. Therefore, in a case of FIG. 5B, the number of nodes of the input layer 501 corresponds to the number of types of the biomarker data, and the number of nodes of the output layer 503 corresponds to the number of the diagnosis types of the diagnosis data. The number of the intermediate layers is set one, but the number of the intermediate layers can be set differently as required.

In FIGS. 5A and 5B, each of the layers is set with reference numbers from the left layer (i.e., input layer 501) to the right layer to identify each of the layers. In FIGS. 5A and 5B, the input layer 501 is used as a first layer, the intermediate layer is used as a second layer, and the output layer 503 is used as a third layer. Further, in FIGS. 5A and 5B, the number of the intermediate layers (second layer) are not required to be the same number, and further, the number of nodes of the intermediate layer (second layer) are not required to be the same number.

Hereinafter, information transmission from the input layer 501 to the output layer 503 in the neural network is described. At first, the life log data (e.g., L1 to L20) is input to each of the nodes of the input layer 501. An input to the “i”-th node (“i” is an integer of 1 to “n”), which is the “i”-th from the first node of the first layer in the neural network, can be expressed by the linear combination of the life log data “Li” and the weight “W1i,” in which “X1i” is an input value to the “i”-th node in the first layer, and “W1i” is a weight of the “i”-th node in the first layer.

X1i=ΣW1i·Li

Further, an output “Z1i” of the “i”-th node (“i” is an integer of 1 to “n”) in the first layer can be expressed by an activation function f(X) as below described.

Z1i=f(X1i)

The activation function is a non-linear function, and outputs a non-linear calculation result for the input. The activation function can employ, for example, the sigmoid function. When the sigmoid function is used, even when an absolute value of the input value becomes greater, the output can be set within a range from 0 to 1. The slope when the sigmoid function changes from 0 to 1 near x=0 can be adjusted by an exponent of the natural logarithm “e.” Further, the activation function can employ the tan h function having the output from −1 to +1.

The input to the second layer and the output from the second layer are calculated by applying the linear combination similar to the first layer.

X2i=ΣW2i·Z1i

Z2i=f(X2i)

“X2i” is an input value to the “i”-th node in the second layer, and “W2i” is a weight of the “i”-th node in the second layer. “Z2i” is an output value to the “i”-th node in the second layer. An output of the third layer (output layer 503) is calculated similarly. An estimation value of the biomarker data (e.g., B1 to B15) is output from each of the nodes of the third layer (output layer 503).

In the machine learning, at first, the weight “Wji” is learned in a learning phase, in which “j” is a layer number, and “i” is a node number. The output value of the third layer (output layer 503) is compared with the biomarker data of the depression patients and the healthy persons. The biomarker data compared with the output value is referred to as a teacher signal. The biomarker data of the depression patients and the healthy persons is the measurement value, which is not a value calculated by the neural network. Therefore, it is preferable that the value calculated from the neural network and the measurement value becomes the substantially same. Further, if there is some relationship or correlation between the life log data and the biomarker data, the biomarker data can be calculated from the life log data. Further, it is known that the neural network can approximate any function that outputs a value corresponding to an input. Therefore, the neural network can express the correlation between the life log data and the biomarker data.

Therefore, when the neural network performs the learning such that the output value of the third layer (output layer 503) becomes closer to the biomarker data, the biomarker data can be calculated from the life log data.

The learning of the neural network means the updating of the weight “Wji.” Specifically, a difference of the output value of the third layer (output layer 503) and the teacher signal is set as an error, and then the weight from the input layer 501 to the output layer 503 are corrected by using the error back propagation method, which is a known method. The neural network and the weight “Wji” that have completed the learning in FIG. 5A corresponds to the correlation data 6001.

The learning phase is completed when the weight is updated by some teacher signals, and/or when the weight does to change anymore. When the learning phase is completed, and then the life log data of the diagnosis-target person is input to the neural network, the estimation value of the biomarker data of the diagnosis-target person is output.

The learning of the neural network of FIG. 5B can be performed similarly. If there is any relationship or correlation between the biomarker data of persons (e.g., depression patients and healthy persons) and the diagnosis data of persons (e.g., depression patients and healthy persons), the diagnosis data can be calculated from the biomarker data. In the neural network of FIG. 5B, the biomarker data (e.g., B1 to B5) is input to each of the nodes of the input layer 501, and an estimation value of the diagnosis data (e.g., D1 to D34) is output from each of the nodes of the output layer 503.

The neural network and the weight “Wji” that have completed the learning in FIG. 5B corresponds to the correlation data 6001. Therefore, when the neural network performs the learning such that the diagnosis data of persons (e.g., depression patients and healthy persons) is output from the biomarker data of persons (e.g., depression patients and healthy persons), the estimation value of the diagnosis data can be calculated from the estimation value of the biomarker data calculated in FIG. 5A.

Further, the machine learning can use the support vector machine and the multi-class classification method other than the neural network.

### (Operation Sequences)

A description is given of each of operation sequences performed by the diagnostic system 100.

### (Registration of Diagnosis Data)

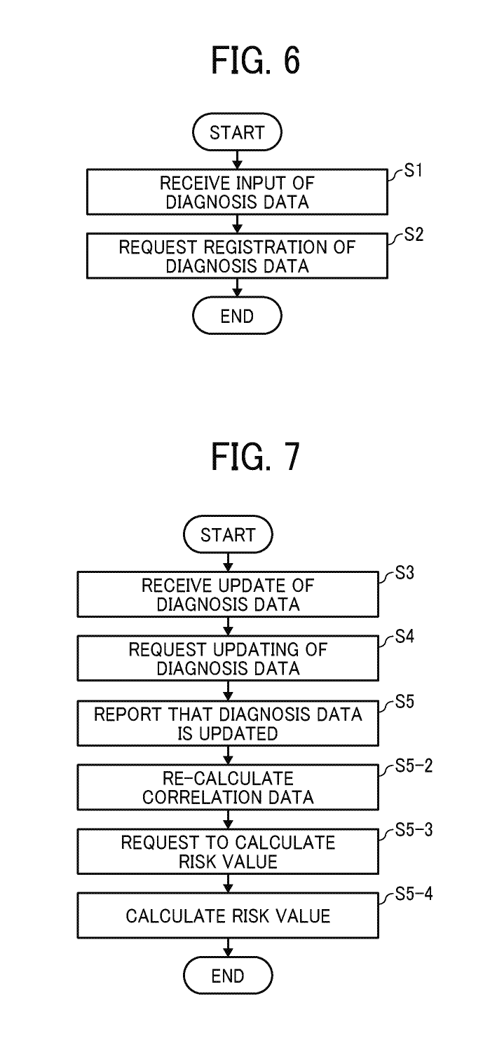

FIG. 6 is a flow chart illustrating the steps of a process of registering diagnosis data by the diagnostic service provider.

The diagnostic service provider operates the diagnosis data management terminal 10 to input the diagnosis data for each one of diagnosis. The operation reception unit 22 of the diagnosis data management terminal 10 receives an input of the diagnosis data from the diagnostic service provider (S1). Specifically, the diagnosis result is input for one set of the diagnosis ID, the diagnosed-person ID, the diagnosis date, and the diagnosis type.

When the diagnosis data is input and the diagnostic service provider performs a registration operation, the operation reception unit 22 receives the registration operation, and the registration request unit 24 transmits the diagnosis data to the database management apparatus 30 (S2) through the transmission/reception unit 21. In the database management apparatus 30, the diagnosis data management unit 32 registers the diagnosis data to the diagnosis database 3001. With this configuration, the diagnosis data of the depression patients, the healthy persons, and the diagnosis-target person are registered in the diagnosis database 3001.

### (Update of Diagnosis Data)

FIG. 7 is a flow chart illustrating the steps of a process of reporting an update of diagnosis data to the database management apparatus 30 by the diagnostic service provider.

The diagnostic service provider operates the diagnosis data management terminal 10 to input a report that the diagnosis data is updated. The operation reception unit 22 of the diagnosis data management terminal 10 receives an input of the report of update of the diagnosis data from the diagnostic service provider (S3). When the operation reception unit 22 of the diagnosis data management terminal 10 receives the input of the report, one set of the diagnosis ID, the diagnosed-person ID, the diagnosis date, the diagnosis result of each diagnosis type, related to the updated diagnosis data, is input.

The registration request unit 24 transmits a request for updating the diagnosis data stored in the database management apparatus 30 by using the updated diagnosis data to the database management apparatus 30 (S4) through the transmission/reception unit 21. In the database management apparatus 30, the transmission/reception unit 31 receives the update request, and updates the diagnosis database 3001.

Further, when the transmission/reception unit 31 of the database management apparatus 30 receives the update request, the diagnosis data management unit 32 searches the diagnosis-target database 3004 (S5). Then, the transmission/reception unit 31 reports to contact information of the searched diagnosis-target person that the diagnosis data is updated.

When the diagnosis-target person or the concerned party/person receives the report that the diagnosis data is updated, the diagnosis-target person or the concerned party/person operates the risk value calculation terminal 50 to estimate the risk value of the depression symptom again. With this configuration, the diagnostic system 100 can cope with a situation that the diagnostic criteria is revised.

Further, when the diagnosis data is updated, the risk value can be calculated automatically as below described.

When the transmission/reception unit 31 of the database management apparatus receives the update request, the transmission/reception unit 31 requests the risk value calculation apparatus 60 to calculate the correlation data 6001 (S5-2). Since doctors have performed diagnosis of the depression patients and the healthy persons by applying new diagnostic criteria, the diagnosis data determined by the doctors are already obtained.

When the correlation data 6001 is generated, the transmission/reception unit 31 of the database management apparatus 30 requests the risk value calculation apparatus 60 to calculate the risk value (S5-3), in which the calculation request includes the diagnosed-person ID of the diagnosis-target person.

The risk value calculation unit 63 of the risk value calculation apparatus 60 requests the diagnosis-target ID designated by the diagnosed-person ID to the history management apparatus 40, and applies the life log data of the diagnosis-target person acquired from the history management apparatus 40 to the changed correlation data 6001 to calculate the risk value (S5-4). Further, the transmission/reception unit 61 transmits the calculated risk value to the diagnosis-target person via e-mail or the like.

As above described, the diagnosis data may be updated when the diagnostic criteria of the depression symptom is revised. When the diagnostic criteria of the depression symptom is revised, the update of the diagnosis data may be required. For example, in a case of DSM-IV, when it is regarded as a bereavement reaction, which is a kind of disorder due to cultural situation, the symptom becomes an exclusion criterion. By contrast, in a case of DMS-5, this exclusion criterion has been deleted. Therefore, a change of the diagnosis result is required when DSM-IV is revised to DSM-5.

Therefore, as to the embodiment, when the diagnosis data (diagnosis result) is updated, the risk value can be re-calculated by using previous or past life log data of the diagnosis-target person, and thereby the risk value of the diagnosis-target person can be calculated based on the latest diagnostic criteria.

### (Registration of Biomarker Data)

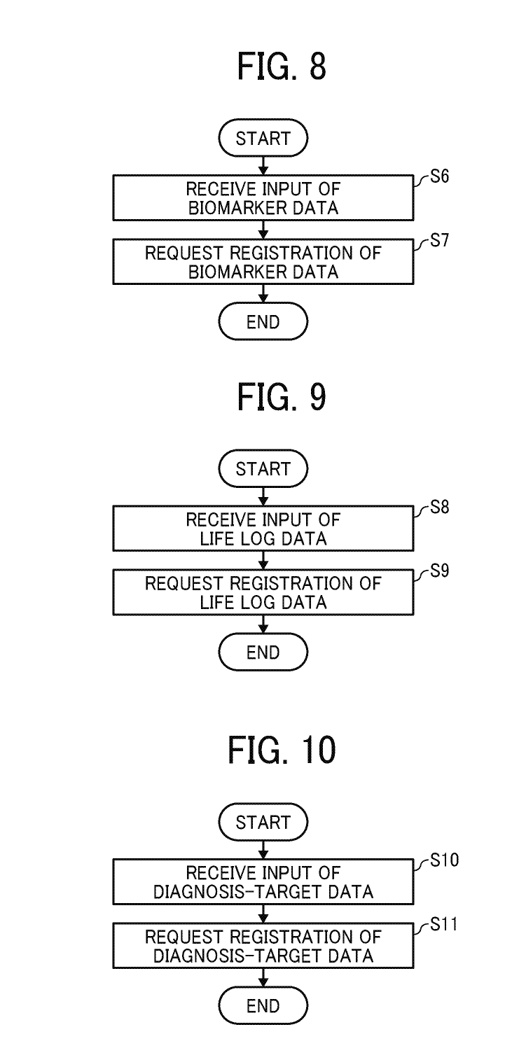

FIG. 8 is a flow chart illustrating the steps of a process of registering biomarker data by the diagnostic service provider.

The diagnostic service provider operates the biomarker data registration terminal 11 to input the biomarker data for each one of diagnosis. The operation reception unit 22 of the biomarker data registration terminal 11 receives an input of the biomarker data from the diagnostic service provider (S6). Specifically, the measurement value is input for one set of the diagnosis ID, the diagnosed-person ID, the measurement date, and the biomarker type.

When the biomarker data is input and the diagnostic service provider performs a registration operation, the operation reception unit 22 receives the registration operation, and the registration request unit 24 transmits the biomarker data to the database management apparatus 30 (S7) through the transmission/reception unit 21. In the database management apparatus 30, the biomarker data management unit 33 registers the biomarker data to the biomarker database 3002. With this configuration, the biomarker data of the depression patients and the healthy persons are registered in the biomarker database 3002.

### (Registration of Life Log Data)

FIG. 9 is a flow chart illustrating the steps of a process of registering the life log data by the diagnostic service provider.

The diagnostic service provider operates the life log data registration terminal 12 to input the life log data for each one of diagnosis. The operation reception unit 22 of the life log data registration terminal 12 receives an input of the life log data from the diagnostic service provider (S8). Specifically, the measurement value is input for one set of the diagnosis ID, the diagnosed-person ID, the measurement date, and the life log type.

When the life log data is input and the diagnostic service provider performs a registration operation, the operation reception unit 22 receives the registration operation, and the registration request unit 24 transmits the life log data to the database management apparatus 30 (S9) through the transmission/reception unit 21. In the database management apparatus 30, the life log data management unit 34 registers the life log data to the life log database 3003. With this configuration, the life log data of the depression patients, the healthy persons, and the diagnosis-target person are registered in the life log database 3003.

### (Registration of Diagnosis-Target Person)

FIG. 10 is a flow chart illustrating the steps of a process of registering a diagnosis-target person by the diagnostic service provider.

The diagnostic service provider operates the diagnosis-target registration terminal 13 to input the diagnosis-target data. The operation reception unit 22 of the diagnosis-target registration terminal 13 receives an input of the diagnosis-target data from the diagnostic service provider (S10). Specifically, the diagnosis-target ID and the contact information are input.

When the diagnosis-target data is input and the diagnostic service provider performs a registration operation, the operation reception unit 22 receives the registration operation, and the registration request unit 24 transmits the diagnosis-target data to the database management apparatus 30 (S11) through the transmission/reception unit 21. In the database management apparatus 30, the diagnosis-target data management unit 35 registers the diagnosis-target data to the diagnosis-target database 3004. With this configuration, the diagnosis-target data is registered in the diagnosis-target database 3004.

### (Registration of Recommended Information)

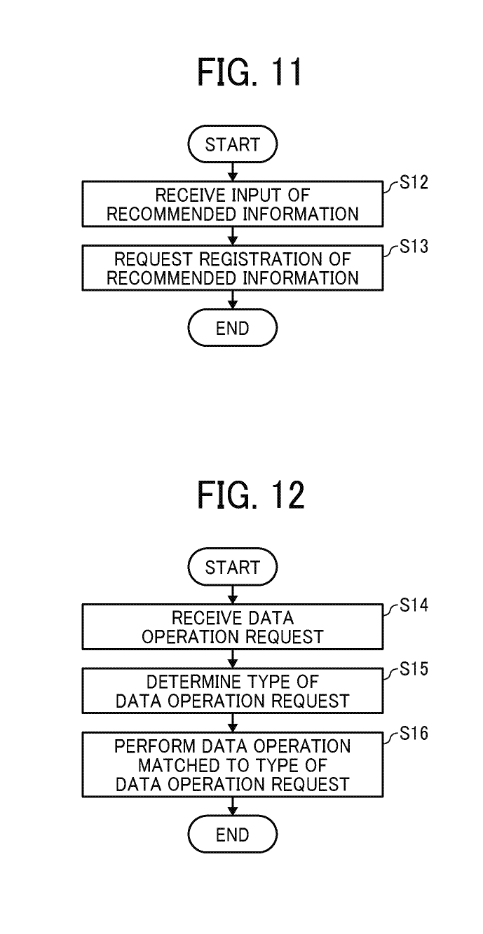

FIG. 11 is a flow chart illustrating the steps of a process of registering recommended information by the diagnostic service provider.

The diagnostic service provider operates the recommended information registration terminal 14 to input the recommended information. The operation reception unit 22 of the recommended information registration terminal 14 receives an input of the recommended information from the diagnostic service provider (S12). Specifically, the recommended information is input.

When the recommended information is input and the diagnostic service provider performs a registration operation, the operation reception unit 22 receives the registration operation, and the registration request unit 24 transmits the recommended information to the database management apparatus 30 (S13) through the transmission/reception unit 21. In the database management apparatus 30, the recommended information data management unit 36 registers the recommended information to the recommended information database 3005. With this configuration, the recommended information is registered in the recommended information database 3005.

### (Data Operation)

FIG. 12 is a flow chart illustrating the steps of a process of data operation performable by the database management apparatus 30. In response to a request from any one of the terminals, the database management apparatus 30 performs various data operations such as registration of data, searching of data, and providing of data by using the databases.

As to the database management apparatus 30, the diagnosis data management unit 32, the biomarker data management unit 33, the life log data management unit 34, the diagnosis-target data management unit 35, and the recommended information data management unit 36 receive a data operation request from the diagnosis data management terminal 10, the biomarker data registration terminal 11, the life log data registration terminal 12, the diagnosis-target registration terminal 13, the recommended information registration terminal 14, and the risk value calculation terminal 50 (S14). When the data operation is requested, a type of data operation request and requested data are designated.

The database management apparatus 30 determines the type of data operation request (S15). The type of the data operation request includes, for example, registration, searching, and updating.

The database management apparatus 30 performs the data operation matched to the type of the data operation request (S16).

### (Calculation of Risk Value)

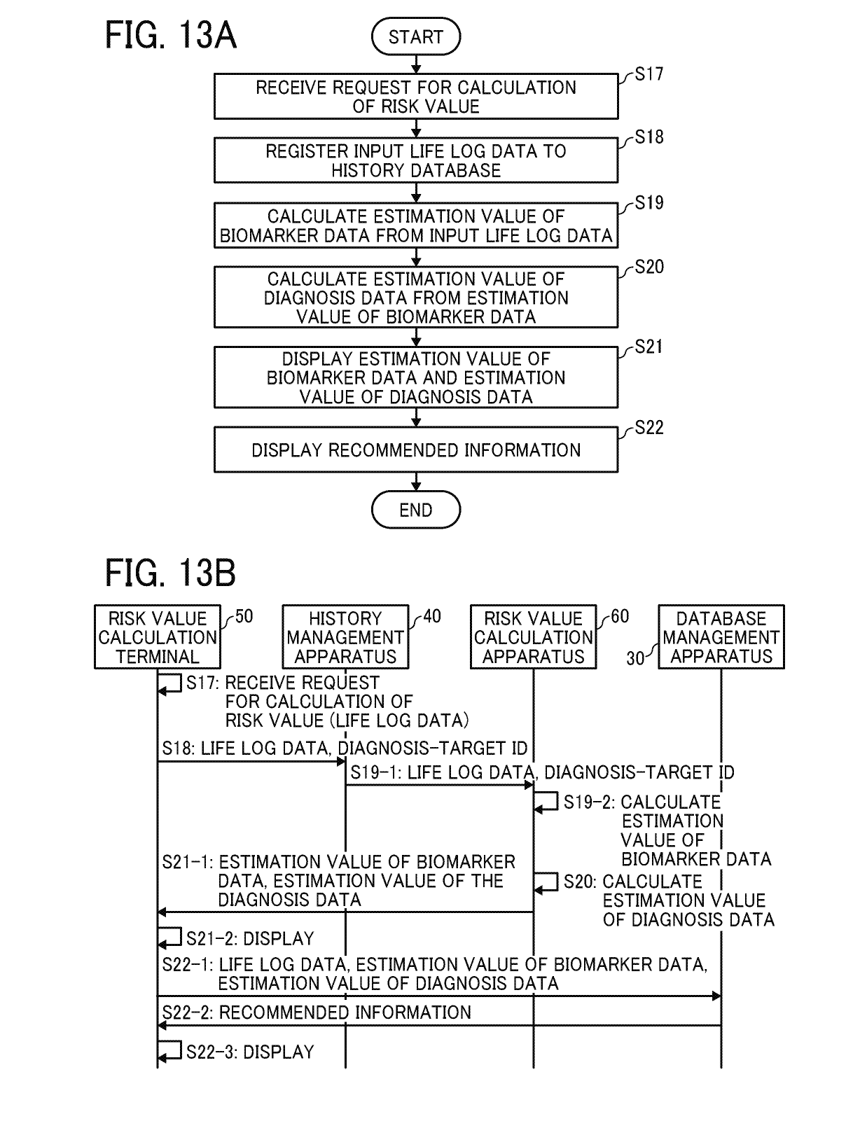

FIG. 13A is a flow chart illustrating the steps of a process of calculating the risk value by the risk value calculation apparatus 60, and FIG. 13B is a sequential diagram of the processing performable by the diagnostic system 100, which substantially corresponds to the steps of the calculating the risk value of FIG. 13A. Hereinafter, the process of calculating the risk value is described based on the sequential diagram of FIG. 13B.

S17: The diagnosis-target person or the concerned party/person operates the risk value calculation terminal 50 to calculate the risk value by using the risk value calculation terminal 50. In the risk value calculation terminal 50, the operation reception unit 52 receives a request for calculation of the risk value. When the calculation request is received, the diagnosis-target person or the concerned party/person inputs the life log data of the diagnosis-target person. When the life log data is input, at least one diagnosis-target ID is designated, and/or the time period is designated with the input life log data.

S18: The risk value calculation terminal 50 requests the history management apparatus 40 to register the input life log data and the designated diagnosis-target ID to the history database 4001 (S18). The history management apparatus 40 acquires the designated life log data from the database management apparatus 30, and registers the acquired life log data to the history database 4001.

S19-1: The transmission/reception unit 41 of the history management apparatus transmits a calculation request of the risk value with the life log data and the diagnosis-target ID to the risk value calculation apparatus 60.

S19-2: The transmission/reception unit 61 of the risk value calculation apparatus 60 receives the life log data and the diagnosis-target ID from the database management apparatus 30, and the risk value calculation unit 63 applies the correlation data 6001 to the life log data to calculate the estimation value of the biomarker data from the life log data.

S20: Then, the risk value calculation unit 63 applies the correlation data 6001 to the estimation value of the biomarker data to calculate the estimation value of the diagnosis data from the estimation value of the biomarker data when the estimation method of FIG. 1A is used. Further, when the estimation method of FIG. 1B is used, the estimation value of the diagnosis data is calculated from the life log data.

S21-1: The transmission/reception unit 61 of the risk value calculation apparatus 60 transmits the calculated estimation value of the biomarker data, and the calculated estimation value of the diagnosis data to the risk value calculation terminal 50.

S21-2: The transmission/reception unit 51 of the risk value calculation terminal 50 receives the estimation value of the biomarker data, and the estimation value of the diagnosis data from the risk value calculation apparatus 60, and then the display control unit 53 displays the estimation value of the biomarker data and the estimation value of the diagnosis data on the display 310.

With this configuration, the biomarker data is estimated, and thereby the diagnosis-target person or the concerned party/person can check quantitative and objective indicators. Further, since the estimation value of the diagnosis data is calculated and acquired, the diagnosis data, equivalent to diagnosis determined by a doctor or other medical staff based on the diagnostic criteria, can be obtained. Therefore, the early diagnosis of the depression symptom can be performed by applying the diagnostic criteria used by the doctor to information obtained routinely or daily such as the life log data.

S22-1: Then, the recommended information request unit 55 requests the recommended information associated to the designated life log data, the estimation value of the biomarker data, and the estimation value of the diagnosis data to the database management apparatus 30 through the transmission/reception unit 51.

S22-2: The recommended information data management unit 36 of the database management apparatus 30 searches specific recommended information, associated to the life log data, the estimation value of the biomarker data, and the estimation value of the diagnosis data received from the risk value calculation terminal 50, from the recommended information database 3005, and transmits a search result of the recommended information to the risk value calculation terminal 50 through the transmission/reception unit 31.

S22-3: The display control unit 53 of the risk value calculation terminal 50 displays the recommended information on the display 310.

Further, a uniform resource locator (URL) can be registered as the recommended information in the recommended information database 3005. When the diagnosis-target person or the concerned party/person clicks the URL, the risk value calculation terminal 50 can access to an electronic commerce (EC) site designated by the URL. Therefore, it becomes easier to purchase foods on the EC site that is effective for improving the risk value. Further, the URL of website that provides effective information for improving the risk value can be registered with or without the EC site.

Further, it is also effective to use the scheme of affiliate. The risk value calculation apparatus 60 sets a space for affiliate in the screen information written in HTML used for transmitting the recommended information. The risk value calculation terminal 50 accesses a pre-registered affiliate service provider (ASP) and displays advertisement information of an advertiser suitable for the recommended information in an affiliate space. When the diagnosis-target person clicks this affiliate space, the risk value calculation terminal 50 accesses the URL of the advertiser. When accessing the URL of the advertiser, information specifying the risk value calculation apparatus 60 (e.g., ASP member ID) is notified to the advertiser. When the diagnosis-target person purchases an item on the advertiser's website, the ASP is notified of the information specifying the risk value calculation apparatus 60 and result data (e.g., number and name of item that were purchased). As a result, a performance fee is paid from the ASP to the risk value calculation apparatus 60 (i.e., diagnostic system 100).

With this configuration, by linking the recommended information and EC side or the like, an operational cost of the diagnostic system 100 can be reduced.

### (Registration of History)

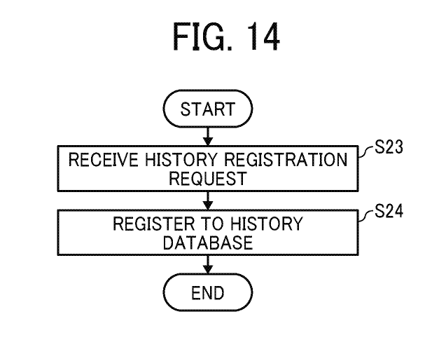

FIG. 14 is a flow chart illustrating the steps of a process of registering history by the history management apparatus 40.

The history management apparatus 40 receives a history registration request from the risk value calculation terminal 50 (S23). Specifically, the risk value calculation terminal 50 transmits the risk value calculation date, the diagnosis-target ID, the life log type, the measurement date, and the measurement value related to the life log data used for calculating the risk value to the history management apparatus 40.

In the history management apparatus 40, the transmission/reception unit 41 receives the history registration request, and the history data management unit 44 registers these data (i.e., the risk value calculation date, the diagnosis-target ID, the life log type, the measurement date, and the measurement value related to the life log data) to the history database 4001 (S24).

(Display of Risk Value with Chronological Order)

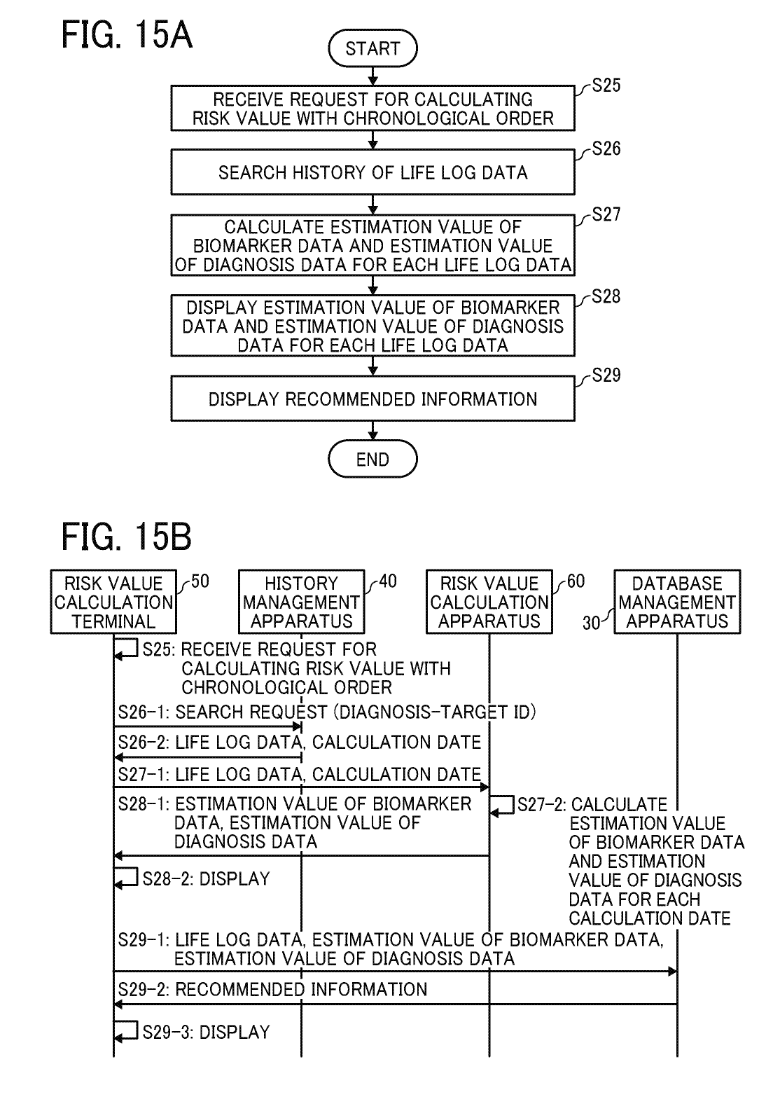

FIG. 15A is a flow chart illustrating the steps of a process of calculating the risk value with a chronological order by the risk value calculation terminal 50, and FIG. 15B is a sequential diagram of the processing performable by the diagnostic system 100, which substantially corresponds to the steps of the process of calculating the risk value of FIG. 15A. Hereinafter, the process of calculating the risk value is described based on the sequential diagram of FIG. 15B.

S25: The diagnosis-target person or the concerned party/person operates the risk value calculation terminal 50 to calculate the risk value with the chronological order by using the risk value calculation terminal 50. In the risk value calculation terminal 50, the operation reception unit 52 receives a request for calculating the risk value with the chronological order (S25).

S26-1: Then, the diagnosis-target person or the concerned party/person operates the risk value calculation terminal 50 by designating the diagnosis-target ID to search the life log data of the designated diagnosis-target ID. As to the risk value calculation terminal 50, the operation reception unit 52 receives the diagnosis-target ID and a search request, and then the transmission/reception unit 51 of the risk value calculation terminal 50 requests a history search of the life log data associated to the designated diagnosis-target ID to the history management apparatus 40.

S26-2: The transmission/reception unit 41 of the history management apparatus receives the search request, and the history data management unit 44 searches the life log data associated to the diagnosis-target ID, and then the transmission/reception unit 41 transmits the searched life log data and the risk value calculation date to the risk value calculation terminal 50.

S27-1: The transmission/reception unit 51 of the risk value calculation terminal 50 receives the life log data and the risk value calculation date from the history management apparatus 40, and transmits the life log data and the risk value calculation date to the risk value calculation apparatus 60. Further, the history management apparatus 40 can be configured to transmit the life log data and the risk value calculation date to the risk value calculation apparatus 60 directly.

S27-2: The transmission/reception unit 61 of the risk value calculation apparatus 60 receives the life log data and the risk value calculation date from the risk value calculation terminal 50, and the risk value calculation unit 63 applies the correlation data 6001 to the life log data related to each of the risk value calculation date. With this configuration, the estimation value of the biomarker data and the estimation value of the diagnosis data can be calculated from the life log data related to each of the risk value calculation date.

S28-1: The transmission/reception unit 61 of the risk value calculation apparatus 60 transmits the estimation value of the biomarker data and the estimation value of the diagnosis data calculated for each of the risk value calculation date to the risk value calculation terminal 50.

S28-2: The transmission/reception unit 51 of the risk value calculation terminal 50 receives the estimation value of the biomarker data and the estimation value of the diagnosis data from the risk value calculation apparatus 60, and then the display control unit 53 displays the estimation value of the biomarker data and the estimation value of the diagnosis data calculated for each of the risk value calculation date on the display 310.

S29-1: Further, the transmission/reception unit 51 of the risk value calculation terminal 50 requests the recommended information associated to the life log data, the estimation value of the biomarker data, and the estimation value of the diagnosis data to the database management apparatus 30.

S29-2: The recommended information data management unit 36 of the database management apparatus 30 transmits the recommended information associated to the life log data, the estimation value of the biomarker data, and the estimation value of the diagnosis data to the risk value calculation terminal 50 through the transmission/reception unit 31.

S29-3: The display control unit 53 of the risk value calculation terminal 50 displays the recommended information transmitted from the database management apparatus 30 on the display 310.

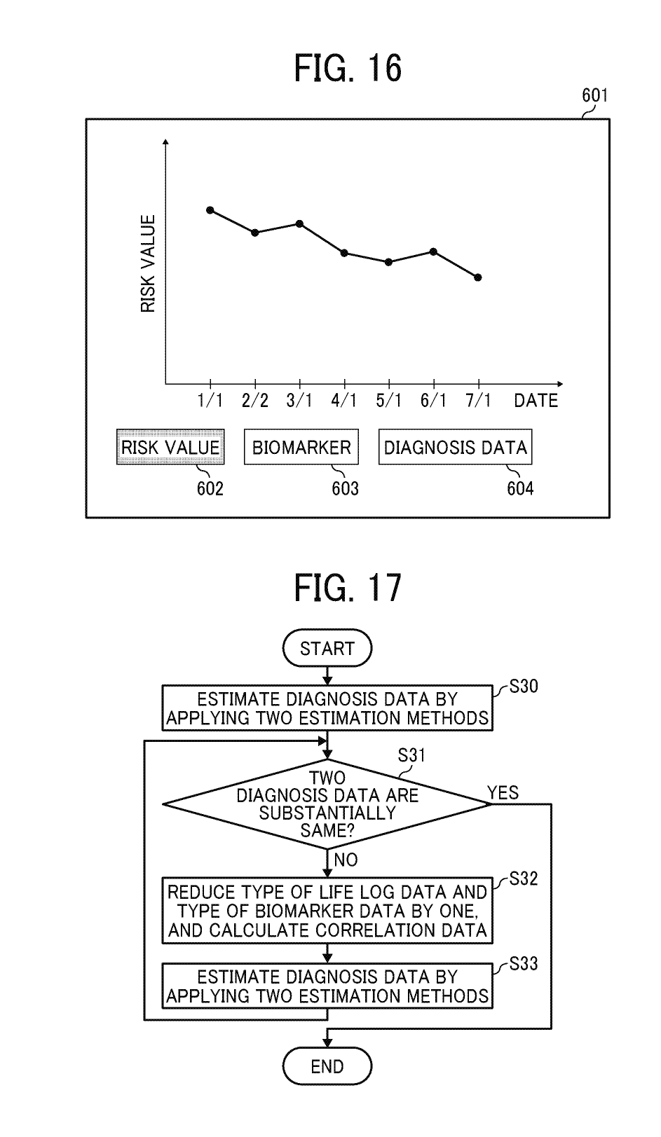

FIG. 16 illustrates an example of a risk value screen 601 displayable on the display 310 of the risk value calculation terminal 50. In the risk value screen 601 of FIG. 16, the risk value of each month is displayed by using a scatter plot. The date on the horizontal axis indicates the date when the risk value was calculated. With this configuration, the diagnosis-target person or the concerned party/person can use previous or past life log data to calculate the risk value, and display the risk value with the chronological order, with which the diagnosis-target person or the concerned party/person can comprehend a trend of the risk value over the time.

Further, as illustrated in FIG. 16, the risk value screen 601 includes, for example, a risk value button 602, a biomarker button 603, and a diagnosis data button 604. The risk value button 602 is used to display the risk value as illustrated in FIG. 16, the biomarker button 603 is used to display the estimation value of the biomarker, and the diagnosis data button 604 is used to display the estimation value of the diagnosis data. The diagnosis-target person or the concerned party/person can display the estimation value of the biomarker and the estimation value of the diagnosis data with the chronological order. Further, numerical values of the estimation value of the biomarker and the estimation value of the diagnosis data can be displayed with or without the scatter plot.

Furthermore, the system may be configured to automatically cause display of the estimation value of the biomarker and/or the estimation value of the diagnosis data when the risk value is above a predetermined threshold. This way the diagnosis-target person or the concerned party/person can effectively be alerted of a situation of depression based on inputted life pattern data. Such life pattern data may be automatically collected at a wearable terminal on the diagnosis-target person as discussed above, and therefore an alert or indicator may be displayed based on a dynamically detecting a change in the life activities of a diagnostic-target person.

### (Comparing of Two Estimation Values of Diagnosis Data)

In the above description, two estimation methods of diagnosis data indicated by FIG. 1A and FIG. 1B are described. The diagnosis data can be estimated effectively by using the two methods. When the diagnosis data is estimated by using the two estimation methods, two estimation values of diagnosis data can be obtained, and then the correlation estimation unit 62 can compare the two estimation values of the diagnosis data calculated by the two estimation methods. Therefore, if the two estimation values of the diagnosis data are substantially the same, it can be confirmed that not only the diagnosis data have higher reliability but also the estimation value of the biomarker data have higher reliability.

FIG. 17 is a flow chart illustrating the steps of a process of calculating correlation data based on two estimated diagnosis data. The sequence of FIG. 17 can be performed at a timing, for example, when the correlation data is to be calculated.

Specifically, when the correlation data is generated, the correlation estimation unit 62 estimates the diagnosis data of one diagnosis-target person by using the life log data of the one diagnosis-target person by applying the two estimation methods, which are indicated, for example, in FIG. 1A and FIG. 1B (S30).

Then, the correlation estimation unit 62 determines whether the two diagnosis data (e.g., first diagnosis data, second diagnosis data) estimated by the two estimation methods are substantially the same diagnosis data (S31). If the determination of step S31 is YES, the correlation data used at step S30 has higher reliability, and thereby the correlation estimation unit 62 employs the correlation data used at step S30.

If the determination of step S31 is NO, the correlation estimation unit 62 reduces the number of types of the life log data and the number of types of the biomarker data by one, and calculates the correlation data again (S32).

Then, the correlation estimation unit 62 estimates the diagnosis data of the one diagnosis-target person by using some of the life log data of the one diagnosis-target person by applying the two estimation methods again (S33). Then, the sequence returns to step S31. In this sequence, the number of types of the life log data and the number of types of the biomarker data is reduced one by one, and then the correlation data having higher reliability can be obtained.

In this sequence, the type of the life log data and the type of the biomarker data that are reduced can be determined in advance. Further, any one type of the life log data and any one type of the biomarker data are selected and reduced, and then the two diagnosis data (e.g., first diagnosis data, second diagnosis data) are compared. For example, when the two diagnosis data (e.g., first diagnosis data, second diagnosis data), estimated after reducing one type (e.g., type M) of the life log data and one type (e.g., type N) of the biomarker data, becomes the closest values, it can be determined that the reduced one type (e.g., type M) of the life log data and the reduced one type (e.g., type N) of the biomarker data do not enhance the reliability of the correlation data. Therefore, it is determined that the one type (e.g., type M) of the life log data and the one type (e.g., type N) of the biomarker data can be reduced.

When the sequence of FIG. 17 is performed, the estimation value of the biomarker data and the estimation value of the diagnosis data having higher reliability can be calculated effectively.

As described above, the diagnostic system 100 of the embodiment can estimate the biomarker data and the diagnosis data of the diagnosis-target person from the life log data of the diagnosis-target person. Therefore, the diagnosis-target person can estimate a diagnosis result of the diagnosis-target person, equivalent to a diagnosis result by a doctor, without visiting a medical institution, with which the early diagnosis can be performed. Further, since the objective and quantitative index such as the biomarker data is estimated, an adverse effect of subjective diagnosis can be reduced. Further, the diagnosis-target person or the concerned party/person can check the biomarker data, and then is motived to change the life-related activity of the diagnosis-target person to improve the biomarker data. Therefore, the diagnostic system 100 can provide an indicator (or motivation) to improve the life-related activity.

Numerous additional modifications and variations for the modules, the units, the terminals and the apparatuses are possible in light of the above teachings. It is therefore to be understood that within the scope of the appended claims, the description of present disclosure may be practiced otherwise than as specifically described herein. For example, elements and/or features of different examples and illustrative embodiments may be combined each other and/or substituted for each other within the scope of present disclosure and appended claims.

In the above description, the biomarker data and the diagnosis data are displayed on the display, but not limited thereto. For example, the biomarker data and the diagnosis data can be printed on a sheet instead of displaying on the display or in addition to displaying on the display. An output form or style of the biomarker data and the diagnosis data is not limited to displaying on the display.

The configuration illustrated in FIG. 4 and other drawings separate main functions of the system to facilitate the understanding of the processing of the terminals and apparatuses. However, the present invention is not limited to the above described separation patterns of the functions and names of the functions. Further, the processing of the terminals and apparatuses can be separated into more processing units depending on processing contents. Further, the functions can be separated such that one processing unit includes more processing.

Further, the terminal and apparatus can be integrated in one apparatus, or the terminal and apparatus can be separated into a plurality of apparatuses. For example, all terminals and apparatuses can be configured as one apparatus. Further, the risk value calculation terminal 50 can be configured to include the risk value calculation unit 63 and the correlation data 6001. Further, any one of terminals and any one of apparatuses in the configurations of FIGS. 2 and 4 can be integrated, or capability of one terminal or apparatus can be included in other terminal or apparatus.

Further, in the above description, the databases are included in the database management apparatus 30, but not limited thereto. The databases can be located anywhere as long as the diagnostic system 100 can access the databases, and the database management apparatus 30 is not required to include the databases.

In the above description, the risk value calculation unit 63 is an example of the estimation unit, the display control unit 23 is an example of the output unit, the correlation estimation unit 62 is an example of the correlation calculation unit, the display control unit 23 is an example of the output unit, the life log database 3003 is an example of life-related activity database. The transmission/reception unit 61 is an example of a life-related activity data acquisition unit, the correlation of “L to B” is an example of the first correlation data, the correlation of “B to D” is an example of the second correlation data, the correlation of “L to D” is an example of the third correlation data. Further, the life log data of the depression patients and the healthy persons is an example of the life-related activity data of the already-diagnosed persons.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

The above described embodiment can provide a diagnostic system or apparatus capable of early detection of mental disorders.

As described above, the present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

Numerous additional modifications and variations for the modules, the units, and the image projection apparatus are possible in light of the above teachings. It is therefore to be understood that within the scope of the appended claims, the description of present disclosure may be practiced otherwise than as specifically described herein. For example, elements and/or features of different examples and illustrative embodiments may be combined each other and/or substituted for each other within the scope of present disclosure and appended claims.

What is claimed is:

1. A diagnostic system comprising:
circuitry configured to
receive an input of life pattern data of a diagnosis-target person;
estimate diagnosis data of the diagnosis-target person by applying correlation data, generated by correlating life pattern data and diagnosis data of persons already diagnosed of mental disorder, to the life pattern data of the diagnosis-target person; and
control output of the estimated diagnosis data of the diagnosis-target person.

2. The diagnostic system of claim 1, wherein the correlation data includes
first correlation data defining a correlation between the life pattern data of the already-diagnosed persons and measurement values of biomedical information of the already-diagnosed persons, and
second correlation data defining a correlation between the measurement values of biomedical information of the already-diagnosed persons and the diagnosis data of the already-diagnosed persons,
wherein the circuitry estimates a value of biomedical information of the diagnosis-target person by applying the first correlation data to the life pattern data of the diagnosis-target person, and the circuitry estimates the diagnosis data of the diagnosis-target person by applying the second correlation data to the estimated value of biomedical information of the diagnosis-target person.

3. The diagnostic system of claim 1,
wherein the correlation data includes
first correlation data defining a correlation between the life pattern data of the already-diagnosed persons and measurement values of biomedical information of the already-diagnosed persons, and
third correlation data defining a correlation between the life pattern data of the already-diagnosed persons and the diagnosis data of the already-diagnosed persons,
wherein the circuitry estimates a value of biomedical information of the diagnosis-target person by applying the first correlation data to the life pattern data of the diagnosis-target person, and the circuitry estimates the diagnosis data of the diagnosis-target person by applying the third correlation data to the life pattern data of the diagnosis-target person.

4. The diagnostic system of claim 2, further includes a recommended information database including recommended activity,
wherein the circuitry refers to the recommended information database to acquire recommended information associated to at least any one of the life pattern data, the biomedical information, and the diagnosis data,
wherein the circuitry outputs the recommended information associated to at least any one of the life pattern data, the estimated value of biomedical information, and the estimated diagnosis data of the diagnosis-target person by using an output unit.

5. The diagnostic system of claim 1,
wherein the circuitry is configured to calculate the correlation data defining the correlation between the life pattern data of the already-diagnosed persons and the diagnosis data of the already-diagnosed persons,
wherein when diagnostic criteria used for the diagnosis is changed, the circuitry re-calculates the correlation data defining the correlation between the life pattern data of the already-diagnosed persons and the diagnosis data of the already-diagnosed persons based on the life pattern data of the already-diagnosed persons and the changed diagnostic criteria.

6. The diagnostic system of claim 5, further includes a life pattern database storing the life pattern data of the diagnosis-target person used for estimating the diagnosis data,
wherein when the diagnostic criteria used for the diagnosis is changed, the circuitry re-calculates the correlation data using the life pattern data of the already-diagnosed persons and the diagnosis data of the already-diagnosed persons when the diagnosis data of the already-diagnosed persons is changed by changing the diagnostic criteria,
wherein the circuitry is configured to acquire the life pattern data of the diagnosis-target person from the life pattern database, and estimates new diagnosis data of the diagnosis-target person by applying the re-calculated correlation data to the life pattern data of the diagnosis-target person acquired from the life pattern database.

7. The diagnostic system of claim 4, further includes a life pattern database storing past life pattern data of the diagnosis-target person used for estimating the diagnosis data,
wherein the circuitry is configured to acquire the past life pattern data of the diagnosis-target person from the life pattern database, estimate the diagnosis data of the diagnosis-target person by applying the correlation data to the past life pattern data of the diagnosis-target person, and control display of the diagnosis data of the diagnosis-target person with a chronological order on a display.

8. The diagnostic system of claim 1,
wherein the correlation data includes
first correlation data defining a correlation between the life pattern data of the already-diagnosed persons and measurement values of biomedical information of the already-diagnosed persons, and
second correlation data defining a correlation between the measurement values of biomedical information of the already-diagnosed persons and the diagnosis data of the already-diagnosed persons,
third correlation data defining a correlation between the life pattern data of the already-diagnosed persons and the diagnosis data of the already-diagnosed persons,
wherein the circuitry is configured to estimate a value of biomedical information of the diagnosis-target person by applying the first correlation data to the life pattern data of the diagnosis-target person, the circuitry is configured to estimate first diagnosis data of the diagnosis-target person by applying the second correlation data to the estimated value of biomedical information of the diagnosis-target person estimated by applying the first correlation data to the life pattern data of the diagnosis-target person, and the circuitry is configured to estimate second diagnosis data of the diagnosis-target person by applying the third correlation data to the life pattern data of the diagnosis-target person,
wherein when the circuitry determines that the first diagnosis data and the second diagnosis data are different, the circuitry is configured to reduce the number of types of the life pattern data of the already-diagnosed persons and the number of types of the biomedical information of the already-diagnosed persons, and re-calculate the first correlation data, the second correlation data, and the third correlation data by using the life pattern data reduced with the number of types, the biomedical information reduced with the number of types, and the diagnosis data of the already-diagnosed persons.

9. The diagnostic system of claim 1,
wherein the circuitry is configured to receive the input of the life pattern data from at least one wearable terminal that is in contact with the diagnosis-target person.

10. A method of performing a diagnosis comprising:
receiving an input of life pattern data of a diagnosis-target person;
estimating diagnosis data of the diagnosis-target person by applying correlation data, generated by correlating life pattern data and diagnosis data of persons already diagnosed of mental disorder, to the life pattern data of the diagnosis-target person; and
outputting the estimated diagnosis data of the diagnosis-target person.

11. A non-transitory storage medium storing a program that, when executed by a computer, causes the computer to execute a method of performing a diagnosis, the method comprising:
receiving an input of life pattern data of a diagnosis-target person;
estimating diagnosis data of the diagnosis-target person by applying correlation data, generated by correlating life pattern data and diagnosis data of persons already diagnosed of mental disorder, to the life pattern data of the diagnosis-target person; and
controlling output of the estimated diagnosis data of the diagnosis-target person.
